(19) United States
(12) Patent Application Publication
(10) Pub. No.: US 2026/0280677 A1
(43) Pub. Date: Sep. 17, 2026

(54) METHODS, ARCHITECTURES, APPARATUSES AND SYSTEMS FOR BEAM FAILURE RECOVERY

(71) Applicant: InterDigital Patent Holdings, Inc., Wilmington, DE (US)

(72) Inventors: Young Woo Kwak, Woodbury, NY (US); Yugeswar Deenoo Narayanan Thangaraj, Chalfont, PA (US); Nazli Khan Beigi, Longueuil (CA); Prasanna Herath, Laval (CA); Moon IL Lee, Melville, NY (US); Patrick Tooher, Montreal (CA)

(21) Appl. No.: 19/472,840

(22) PCT Filed: Apr. 3, 2024
(86) PCT No.: PCT/US2024/022842

§ 371 Date: Oct. 6, 2025

Related U.S. Application Data
(60) Provisional application No. 63/456,987, filed on Apr. 4, 2023.

(51) Int. Cl. H04B 7/06; H04W 24/08

(52) U.S. Cl. CPC H04B 7/06964; H04W 24/08

(57) ABSTRACT

Procedures, methods, architectures, apparatuses, systems, devices, and computer program products for measurement for beam failure recovery. A Wireless Transfer/Receive Unit, WTRU, determines a quality of prediction related to at least one reference signal, determines a beam failure recovery mode based on the quality of prediction, determines a set of beam failure recovery parameters based on the quality of prediction, determines at least one beam failure based on the beam failure recovery parameters, and, upon determining a number of beam failures, determines, based on at least one determined value related to the at least one reference signal for candidate beams, a determined reference signal for a candidate beam among the at least one reference signal for candidate beams, wherein the at least one determined value is based on a measurement of a reference signal for a candidate beam of a first type and wherein the at least one determined value is predicted for a reference signal of a second type, transmits, a message based on the beam failure recovery mode, and monitors, using a resource set or signal based on the type of determined reference signal, for a response.

### CROSS-REFERENCE TO RELATED APPLICATIONS

This application claims the benefit of U.S. Provisional Application No. 63/456,987, filed 4 Apr. 2023, which is incorporated herein by reference in their entirety.

### BACKGROUND

The present disclosure is generally directed to the fields of communications, software and encoding, including, for example, to methods, architectures, apparatuses, systems directed to beam failure detection (BFD) and beam failure recovery (BFR).

### SUMMARY

In a first aspect, the present principles are directed to a method at a Wireless Transfer/Receive Unit, WTRU, comprising determining a quality of prediction related to at least one reference signal, determining a beam failure recovery mode based on the quality of prediction, determining a set of beam failure recovery parameters based on the quality of prediction, determining at least one beam failure based on the beam failure recovery parameters, and, upon determining a number of beam failures, determining, based on at least one determined value related to the at least one reference signal for candidate beams, a determined reference signal for a candidate beam among the at least one reference signal for candidate beams, wherein the at least one determined value is based on a measurement of a reference signal for a candidate beam of a first type and wherein the at least one determined value is predicted for a reference signal of a second type, transmitting, a message based on the beam failure recovery mode, and monitoring, using a resource set or signal based on the type of determined reference signal, for a response.

In a second aspect, the present principles are directed to a wireless transfer/receive unit, WTRU, comprising at least one processor configured to determine a quality of prediction related to at least one reference signal, determine a beam failure recovery mode based on the quality of prediction, determine a set of beam failure recovery parameters based on the quality of prediction, determine at least one beam failure based on the beam failure recovery parameters, and, upon determining a number of beam failures, determine, based on at least one determined value related to the at least one reference signal for candidate beams, a determined reference signal for a candidate beam among the at least one reference signal for candidate beams, wherein the at least one determined value is based on a measurement of a reference signal for a candidate beam of a first type and wherein the at least one determined value is predicted for a reference signal of a second type, transmit, a message based on the beam failure recovery mode, and monitor, using a resource set or signal based on the type of determined reference signal, for a response.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of hybrid beamforming;

FIG. 3 illustrates a flow chart of a method of joint Beam Failure Recovery (BFR) according to a first embodiment of the present principles;

FIG. 4 illustrates a flow chart of a method of separate BFR according to an embodiment of the present principles;

FIG. 5 illustrates a flow chart of a method of joint BFR according to a second embodiment of the present principles; and

FIG. 6 illustrates a flow chart of a method of dynamic BFR mode activation/deactivation according to an embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

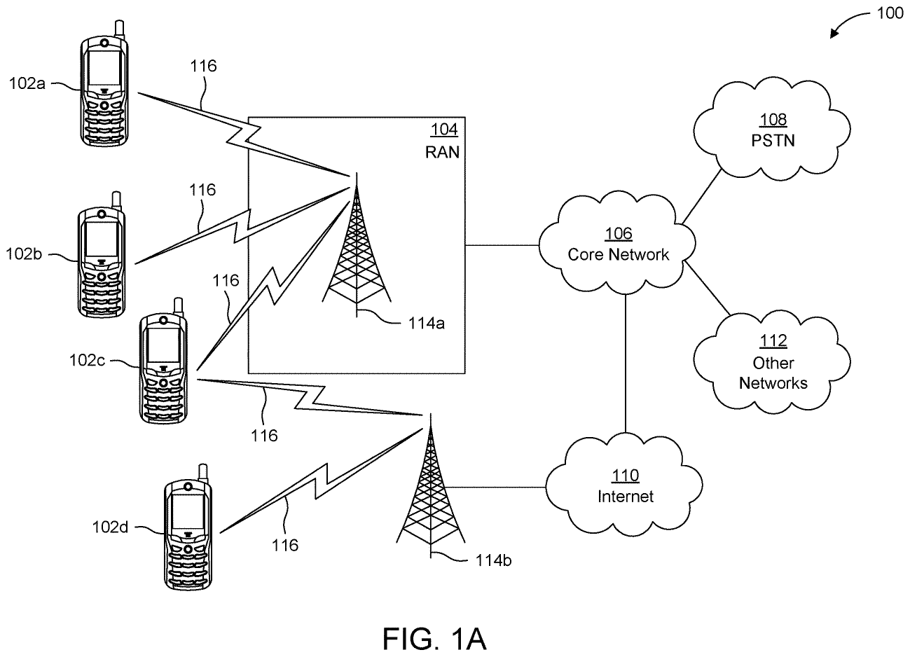

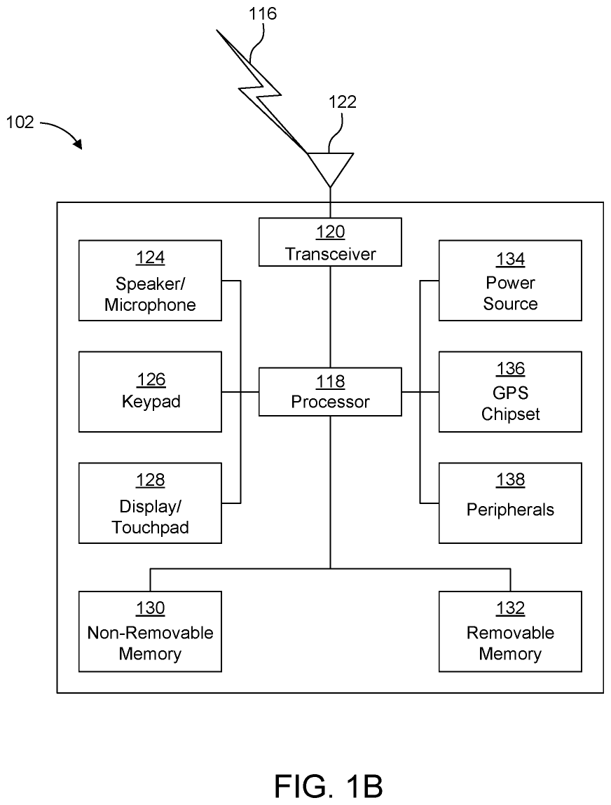

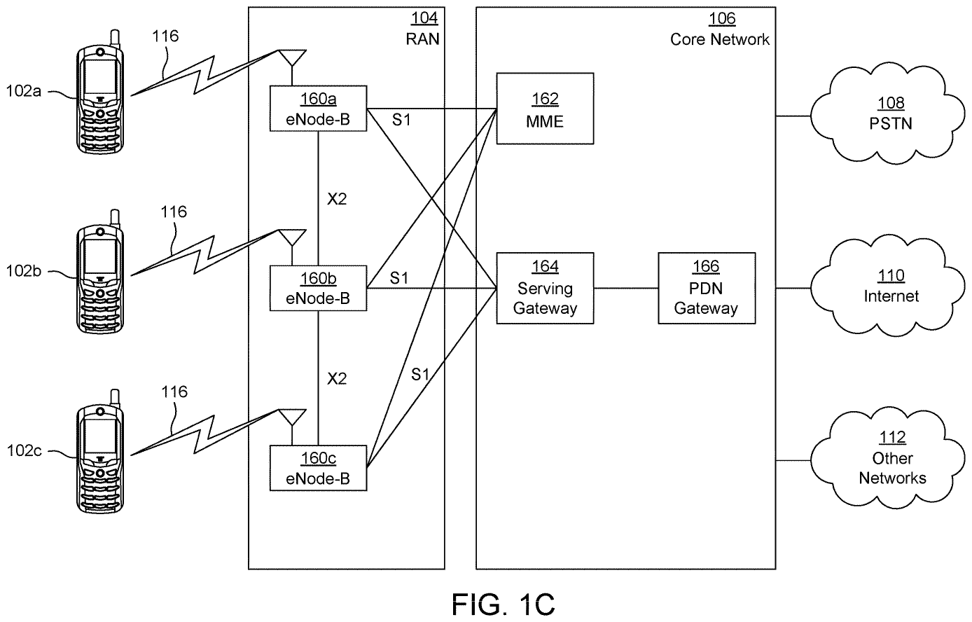

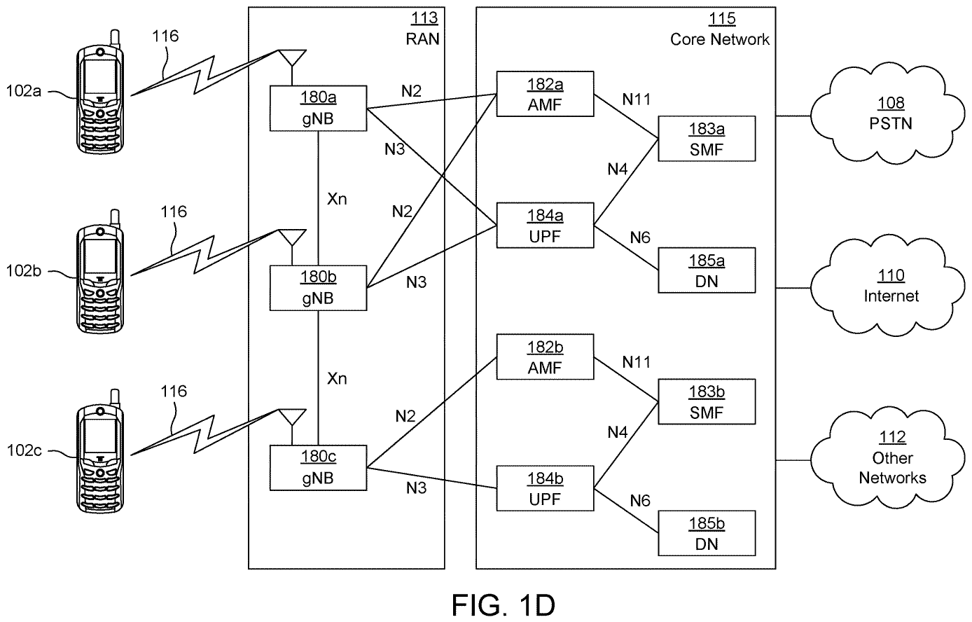

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

3GPP Rel-15 , New Radio (NR) introduced radio access technology (RAT) in frequency range 2 (FR2), i.e. 24.25-52.6 GHz. Since propagation loss increases with the carrier frequency, a key challenge of FR2 is higher propagation loss. Efficient use of highly directional beamformed transmission and reception can mitigate the higher propagation loss.

Beamforming gain can be achieved by adding or subtracting one signal to/from another signal. Since higher beamforming gain can be achieved as more signals are added or subtracted, utilization of a large number of antenna elements is typically required for highly directional beamformed transmission. Controlling signal addition or signal subtraction can be done by controlling phases of antenna elements.

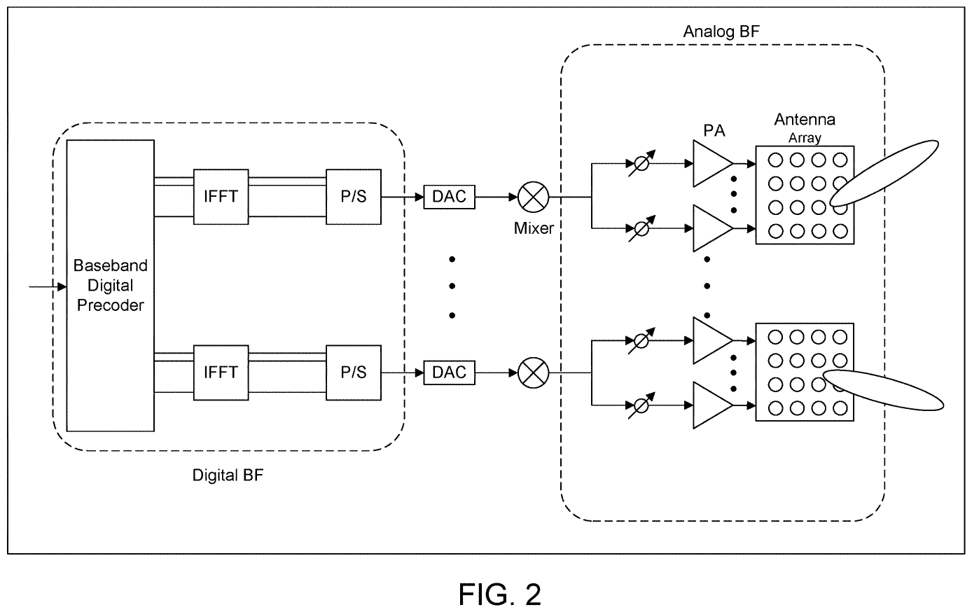

Beamforming methods can be categorized into three types (i.e., analog beamforming, digital beamforming and hybrid beamforming) based on the phase controlling types. While digital beamforming controls a phase of a signal by applying a digital precoder, analog beamforming controls the phase of the signal through phase shifters. Generally, digital beamforming provides good flexibility (e.g., applying different phases for different frequency resource blocks), but requires a more complex implementation. In contrast to digital beamforming, analog beamforming provides relatively simple implementation, but has some limitations (e.g., same analog beam for entire frequency resources). In view of this, hybrid beamforming combining analog and digital beamforming, an example of which is illustrated in FIG. 2, can achieve large beamforming gain with flexibility and reasonable implementation complexity.

Since beam width of a beam decreases as beamforming gain increases, a beam can only cover a limited area. Therefore, the base station (BS) and/or the UE need to utilize multiple beams to cover an entire cell. For example, broadcast signals such as synchronization signal blocks (SSBs) can be transmitted in all directions (e.g., via beam sweeping) to cover the entire cell. For unicast transmission between the BS and the UE, procedures to optimize the beam direction to the UE are provided through beam management. The beam management includes selection and maintenance of the beam direction for unicast transmission (including control channel and data channel) between the BS and the UE.

Beam management procedures can be categorized into beam determination, beam measurement and reporting, beam switching, beam indication, and beam recovery. In beam determination, the BS and the UE find a beam direction to ensure good radio link quality for the unicast control and data channel transmission. Once a link is established, the UE measures the link quality of multiple transmission (TX) and reception (RX) beam pairs and reports the measurement results to the BS. As is known, UE mobility, orientation, and channel blockage can impact the radio link quality of TX and RX beam pairs. When the quality of the current beam pair degrades, the BS and the UE can switch to another beam pair with better radio link quality. To do so, the BS and the UE can monitor the quality of the current beam pair along with one or more other beam pairs and perform switching when necessary. When the BS assigns a TX beam to the UE via downlink (DL) control signaling, the beam indication procedure is used. Beam recovery entails a recovery procedure when a link between the BS and the UE can no longer be maintained.

In RAN #94e, study item on AI/ML for NR Air interface is approved to identify the benefits of AI/ML for the air-interface. In the study item, AI/ML model, terminology and description to identify common and specific characteristics for framework are investigated for a number of use cases: CSI feedback enhancement (e.g., overhead reduction, improved accuracy, prediction), Beam management (e.g., beam prediction in time, and/or spatial domain for overhead and latency reduction, beam selection accuracy improvement), and Positioning accuracy enhancements for different scenarios including, e.g., those with heavy NLOS conditions.

For beam management, two cases were agreed to in RAN1#109-e. BM-Casel: Spatial-domain DL beam prediction for Set A of beams based on measurement results of Set B of beams; and BM-Case2: Temporal DL beam prediction for Set A of beams based on the historic measurement results of Set B of beams.

According to the evaluation results, spatial domain beam prediction (BM-Case1) generally shows good beam prediction probability. However, as beam measurement signals are cell specific and not UE specific, RS overhead reduction should be done not only for beam measurements but also for other purposes including beam failure recovery.

As can be seen, it is not determined how a UE supports beam failure recovery (BFR) based on predicted RSRP values from partial measurement, or how a UE supports reliable beam failure recovery when the UE supports partial measurement.

A first embodiment provides joint BFR based on explicit configuration of estimation beams and measurement beams. A UE uses a different quality for beam failure detection based on a beam type of a RS (e.g., hypothetical Physical Downlink Control Channel Block Error Rate (PDCCH BLER) for estimation beams and Received Signal Received Power (RSRP) for transmission beams), prioritizes transmission beams for new beam selection (e.g., adding RSRP values) and indicates a determined Reference Signal (RS) type for the new beam selection.

The UE receives information indicating a configuration of one or more Beam failure detection (BFD) RSs, one or more new candidate beam (NCB) RSs, a first threshold, a second threshold, a third threshold, a delta value (to be used, for example, for prioritizing measurement from transmission beams), a first Physical Random-Access Channel (PRACH) resource, a second PRACH resource, a first Control Resource Set/Synchronization Signal (CORESET/SS) and a second CORESET/SS. Each RS may be a first RS type (e.g., transmission beams) or a second RS type (e.g., estimation beams).

The UE determines beam failure instance if all of the one or more configured BFD RSs fails. How RS failure is defined can depend on the RS type. For the first RS type, the UE determines beam failure for a BFD RS if a first type of measured parameter (e.g., hypothetical PDCCH BLER) of the RS is lower than the first threshold. For the second RS type, the UE determines beam failure for a BFD RS if a second type of predicted parameter (e.g., RSRP) of the RS is lower than the second threshold.

If the number of beam failure instances within a first time window>the third threshold, the UE begins beam failure recovery and determines a best RS from the one or more NCB RSs based on a third type (e.g., RSRP) of measured parameters of the one or more NCB RSs. For an NCB RS of the first RS type, the UE determines the third type of measured parameter+the delta value of the NCB RS. For an NCB RS of the second RS type, the UE determines the third type of predicted parameter based on a predicted value of the NCB RS.

The UE transmits a PRACH based on a determined RS type. If the determined RS is the first RS type, the UE transmits PRACH in the first PRACH resource. If the determined RS is the second RS type, the UE transmits PRACH in the second PRACH resource.

The UE monitors for a PDCCH based on a determined RS type. If the determined RS is the first RS type, the UE monitors for a PDCCH in the first CORESET/SS. If the determined RS is the second RS type, the UE monitors for a PDCCH in the second CORESET/SS.

A second embodiment provides joint BFR based on implicit configuration of estimation beams and measurement beams.

A UE dynamically determines a type of a quality parameter for beam failure detection for estimation beams (e.g., if PDCCH/PDSCH are measured, uses Demodulation Reference Signal (DM-RS) and hypothetical PDCCH BLER; if not, uses beam prediction and predicted RSRP). The UE determines a best new beam and applies a different PRACH transmission (e.g., contention-free for transmission beams and contention based for estimation beams) for a new beam indication.

The UE receives information indicating a configuration of one or more CORESETs associated with one or more Transmission Configuration Index (TCI) states, one or more NCB RSs, a first threshold, a second threshold, a third threshold, a first time window, a contention free PRACH resource and a contention based PRACH resource. Each RS may be a first RS type (e.g., transmission beams) or a second RS type (e.g., estimation beams).

The UE determines one or more BFD RSs and BFD RS types, based on configured RSs in the one or more TCI states.

The UE determines a beam failure instance if all of the one or more BFD RSs fails. RS failure can be defined differently depending on the RS type. For the first RS type, the UE determines beam failure of an RS if measured quality (e.g., hypothetical PDCCH BLER) of the RS is lower than the first threshold. For the second RS type, if one or more PDCCHs/PDSCHs (e.g., in/by the one or more CORESETs associated with the RS) are transmitted within a first time window, the UE determines beam failure of the RS if measured quality (e.g., hypothetical PDCCH BLER) of DMRS of the one or more PDCCHs/PDSCHs is lower than the second threshold; if no PDCCHs/PDSCHs are transmitted within a first time window, the UE determines beam failure of the RS if predicted quality (e.g., hypothetical PDCCH BLER) of the RS is lower than a second threshold.

If the number of beam failure instances within the first time window>the third threshold, the UE begins beam failure recovery and determines a best RS from the one or more NCB RSs based on measured/predicted quality (e.g., RSRP) of the one or more NCB RSs.

The UE transmits a PRACH in a PRACH resource associated with the determined best RS. If the UE determines the best RS to be of the first RS type, the UE transmits a PRACH in the contention free PRACH resource. If the UE determines the best RS to be of the second RS type, the UE transmits a PRACH in the contention based PRACH resource.

The UE monitors for a PDCCH via a CORESET of the one or more CORESETs.

A third embodiment provides dynamic BFR mode activation/deactivation. A UE determines a mode of operation for BFR (e.g., BFR based on only transmission beams or joint BFR based on both transmission beams and estimation beams) based on a quality of prediction (e.g., RSRP difference or beam prediction accuracy).

The UE receives information indicating a configuration of one or more Beam failure detection (BFD) RSs, one or more new candidate beam (NCB) RSs, a first threshold, a second threshold, a third threshold, a fourth threshold, a fifth threshold, a sixth threshold, a PRACH resource, a first PRACH sequence, a second PRACH sequence, a first CORESET and a second CORESET. Each RS may be a first RS type (e.g., transmission beams) or a second RS type (e.g., estimation beams).

The UE determines, based on the one or more BFD RSs and the one or more NCB RSs, a quality of prediction, for example including the difference between predicted RSRP values and actually measured RSRP values (e.g., based on DMRS from PDCCH/PDSCH) and beam prediction accuracy (e.g., predicted best beam vs actual best beam).

The UE determines a BFR mode based on the quality of the prediction and a first threshold. For example, if the quality of the prediction<the first threshold, the UE determines a first BFR mode (e.g., using only the first RS type for BFD and NCB (e.g., deactivates one or more RSs with the second type)) and, if the quality of the prediction>the first threshold, the UE determines a second BFR mode (e.g., using both the first RS type and the second RS type for BFD and NCB (e.g., activates all RSs configured for BFD and NCB)).

The UE determines a set of Beam Failure Detection/Recovery parameters based on the quality of the prediction. For example, the UE determines to use one of the second threshold or third threshold based on the quality of prediction, for BFD RS failure detection of the second RS type. The UE determines to use one of the fourth threshold or fifth threshold based on the quality of prediction, for detecting beam failure.

The UE determines a beam failure instance if all of one or more activated BFD RSs fails. For the first RS type, the UE determines beam failure for an RS, if measured quality of the RS is lower than the sixth threshold. For the second RS type, the UE determines beam failure for an RS if measured quality of the RS is lower than the UE determined one of the second threshold or third threshold.

The UE detects beam failure based on the number of beam failure instances and the UE determined threshold. If the number of beam failure instances within a time window >one of the fourth threshold or fifth threshold determined by the UE, the UE begins beam failure recovery and determines a best RS from the activated NCB RSs based on measured qualities of the activated NCB RSs.

The UE transmits a PRACH in the PRACH resource based on the determined BFR mode. If the UE determined the first BFR mode, the UE transmits the PRACH with the first PRACH sequence. If the UE determined the second BFR mode, the UE transmits the PRACH with the second PRACH sequence.

The UE monitors for PDCCH based on the determined BFR mode. If the UE determined the first BFR mode, the UE monitors for PDCCH in the first CORESET. If the UE determined the second BFR mode, the UE monitors for PDCCH in the second CORESET.

Herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A symbol ‘/’ (e.g., forward slash) may be used herein to represent ‘and/or’, where for example, ‘A/B’ may imply ‘A and/or B’.

Artificial Intelligence (AI) may be broadly defined as the behavior exhibited by machines. Such behavior may e.g., mimic cognitive functions to sense, reason, adapt and act.

Machine Learning (ML) may refer to type of algorithms that solve a problem based on learning through experience (‘data’), without explicitly being programmed (‘configuring set of rules’). Machine learning can be considered as a subset of AI. Different machine learning paradigms may be envisioned based on the nature of data or feedback available to the learning algorithm. Supervised learning may involve learning a function that maps input to an output based on a labeled training example, wherein each training example may be a pair consisting of input and the corresponding output. Unsupervised learning may involve detecting patterns in the data with no pre-existing labels. Reinforcement learning may involve performing sequence of actions in an environment to maximize the cumulative reward. It is possible to apply machine learning algorithms using a combination or interpolation of machine learning techniques. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep Learning (DL) refers to machine-learning algorithms that employ artificial neural networks (specifically DNNs) that are loosely inspired from biological systems. The Deep Neural Networks (DNNs) are a special class of machine learning models inspired by human brain wherein the input is linearly transformed and passed through non-linear activation functions multiple times. DNNs typically consists of multiple layers where each layer consists of linear transformation and a given non-linear activation function. The DNNs can be trained using the training data via back-propagation algorithm. Recently, DNNs have shown state-of-the-art performance in variety of domains, e.g., speech, vision, natural language etc. and for various machine learning settings supervised, un-supervised, and semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

Definition of Beam. A UE may transmit or receive a physical channel or reference signal according to at least one spatial domain filter. The term “beam” may be used to refer to a spatial domain filter. The UE may transmit a physical channel or signal using the same spatial domain filter as the spatial domain filter used for receiving an RS (such as CSI-RS) or a SS block. The UE transmission may be referred to as “target”, and the received RS or SS block may be referred to as “reference” or “source”. In such a case, the UE may be said to transmit the target physical channel or signal according to a spatial relation with a reference to such RS or SS block.

The UE may transmit a first physical channel or signal according to the same spatial domain filter as the spatial domain filter used for transmitting a second physical channel or signal. The first and second transmissions may be referred to as “target” and “reference” (or “source”), respectively. In such case, the UE may be said to transmit the first (target) physical channel or signal according to a spatial relation with a reference to the second (reference) physical channel or signal.

A spatial relation may be implicit, configured by Radio Resource Control (RRC) or signaled by MAC CE or Downlink Control Information (DCI). For example, a UE may implicitly transmit Physical Uplink Shared Channel (PUSCH) and DM-RS of PUSCH according to the same spatial domain filter as a Sounding Reference Signal (SRS) indicated by a SRS Resource Index (SRI) indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The UE may receive a first (target) downlink channel or signal according to the same spatial domain filter or spatial reception parameter as a second (reference) downlink channel or signal. For example, such an association may exist between a physical channel such as PDCCH or PDSCH and its respective DM-RS. At least when the first and second signals are reference signals, such an association may exist when the UE is configured with a quasi-colocation (QCL) assumption type D between corresponding antenna ports. Such association may be configured as a TCI (transmission configuration indicator) state. A UE may be provided with information indicating an association between a CSI-RS or SS block and a DM-RS by an index to a set of TCI states configured by RRC and/or signaled by MAC CE. Such an indication may also be referred to as a “beam indication”.

TRP, MTRP, M-TRP: Herein, a TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with the present principles. Further, Multi-TRP may be interchangeably used with one or more of MTRP, M-TRP, and multiple TRPs, but still consistent with the present principles.

CSI components: A UE may report a subset of channel state information (CSI) components, where CSI components may correspond to at least a CSI-RS resource indicator (CRI), a SSB resource indicator (SSBRI), an indication of a panel used for reception at the UE (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

The present principles can make use of a number of channel and/or interference measurements that will now be described.

SSB: A UE may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The UE may monitor, receive, or attempt to decode an SSB during initial access, initial synchronization, radio link monitoring (RLM), cell search, cell switching, and so forth.

CSI-RS: A UE may measure and report the channel state information (CSI), wherein the CSI for each connection mode may include or be configured with one or more of CSI Report Configuration (including one or more of CSI report quantity (e.g., Channel Quality Indicator (CQI), Rank Indicator (RI), Precoding Matrix Indicator (PMI), CSI-RS Resource Indicator (CRI), Layer Indicator (LI)), CSI report type (e.g., aperiodic, semi persistent, periodic), CSI report codebook configuration (e.g., Type I, Type II, Type II port selection), and CSI report frequency), CSI-RS Resource Set (including one or more of NZP-CSI-RS Resource for channel measurement, NZP-CSI-RS Resource for interference measurement, and CSI-IM Resource for interference measurement), and NZP CSI-RS Resources (including one or more of NZP CSI-RS Resource ID, Periodicity and offset, QCL Info and TCI-state, and Resource mapping (e.g., number of ports, density, and CDM type)).

A UE may indicate, determine, or be configured with one or more reference signals. The UE may monitor, receive, and measure one or more parameters based on the respective reference signals. The following parameters are non-limiting examples of the parameters that may be included in reference signal(s) measurements. One or more of these parameters may be included. Other parameters may be included.

SS-RSRP. SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP. CSI-RSRP may be measured based on the linear average over the power contribution of the resource elements (RE) that carry the respective CSI-RS. The CSI-RSRP measurement may be configured within measurement resources for the configured CSI-RS occasions.

SS-SINR. SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR. CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

RSSI. Received signal strength indicator (RSSI) may be measured based on the average of the total power contribution in configured OFDM symbols and bandwidth. The power contribution may be received from different resources (e.g., co-channel serving and non-serving cells, adjacent channel interference, and thermal noise).

CLI-RSSI. Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, and thermal noise).

SRS-RSRP. Sounding reference signals RSRP (SRS-RSRP) may be measured based on the linear average over the power contribution of the resource elements (RE) that carry the respective SRS.

SS-RSRQ. Secondary synchronization signal reference signal received quality (SS-RSRQ) may be measured based on measurements on the reference signal received power (SS-RSRP) and received signal strength (RSSI). In an example, the SS-RSRQ may be calculated as the ratio of NxSS-RSRP/NR carrier RSSI, where N may be determined based on the number of resource blocks that are in the corresponding NR carrier RSSI measurement bandwidth. As such, the measurements to be used in the numerator and denominator may be over the same set of resource blocks.

CSI-RSRQ. CSI reference signal received quality (CSI-RSRQ) may be measured based on measurements on the reference signal received power (CSI-RSRP) and received signal strength (RSSI). In an example, the SS-RSRQ may be calculated as the ratio of N×CSI-RSRP/CSIRSSI, where N may be determined based on the number of resource blocks that are in the corresponding CSI-RSSI measurement bandwidth. As such, the measurements to be used in the numerator and denominator may be over the same set of resource blocks.

Beam/CSI Report Configuration. A CSI report configuration (e.g., CSI-ReportConfigs) may be associated with a single BWP (e.g., indicated by BWP-Id), wherein one or more of the following parameters are configured: CSI-RS resources and/or CSI-RS resource sets for channel and interference measurement; CSI-RS report configuration type including the periodic, semi-persistent, and aperiodic; CSI-RS transmission periodicity for periodic and semi-persistent CSI reports; CSI-RS transmission slot offset for periodic, semi-persistent and aperiodic CSI reports; CSI-RS transmission slot offset list for semi-persistent and aperiodic CSI reports; time restrictions for channel and interference measurements; report frequency band configuration (wideband/subband CQI, PMI, and so forth); thresholds and modes of calculations for the reporting quantities (CQI, RSRP, SINR, LI, RI, etc.); codebook configuration; group based beam reporting; CQI table; subband size; non-PMI port indication; and Port Index.

CSI-RS Resource Configuration. A CSI-RS Resource Set (e.g., NZP-CSI-RS-ResourceSet) may include one or more CSI-RS resource (e.g., NZP-CSI-RS-Resource and CSI-ResourceConfig), wherein a UE may be configured with one or more of the following in a CSI-RS Resource: CSI-RS periodicity and slot offset for periodic and semi-persistent CSI-RS Resources; CSI-RS resource mapping to define the number of CSI-RS ports, density, CDM-type, OFDM symbol, and subcarrier occupancy; the bandwidth part to which the configured CSI-RS is allocated; and the reference to the TCI-State including the QCL source RS(s) and the corresponding QCL type(s).

RS resource set Configuration. A UE may be configured with one or more RS resource sets that may include one or more of: RS resource set ID; one or more RS resources for the RS resource set; repetition (i.e., on or off); aperiodic triggering offset (e.g., one of 0-6 slots); and TRS info (e.g., true or not).

RS resource Configuration. A UE may be configured with one or more RS resources that may include one or more of: RS resource ID; resource mapping (e.g., REs in a PRB), power control offset (e.g., one value of −8, . . . , 15); power control offset with SS (e.g., −3 dB, 0 dB, 3 dB, 6 dB); scrambling ID, periodicity and offset; and QCL information (e.g., based on a TCI state).

Property of a grant or assignment. Herein, a property of a grant or assignment may include at least one of: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and any parameter provided in a DCI, by MAC or by RRC for the scheduling the grant or assignment.

Herein, an indication by DCI may include at least one of an explicit indication by a DCI field or by RNTI used to mask or scramble the CRC of the DCI; and an implicit indication by a property such as DCI format, DCI size, Coreset or search space, Aggregation Level, first resource element of the received DCI (e.g., index of first Control Channel Element), where the mapping between the property and the value may be signaled by RRC or MAC.

Receiving or monitoring for a DCI with or using a Radio Network Identifier (RNTI) may mean that the CRC of the DCI is masked or scrambled with the RNTI.

Herein, a ‘signal’ may be interchangeably used with one or more of: Sounding reference signal (SRS); Channel state information-reference signal (CSI-RS); Demodulation reference signal (DM-RS); Phase tracking reference signal (PT-RS); and Synchronization signal block (SSB).

Herein, a ‘channel’ may be interchangeably used with one or more of: Physical downlink control channel (PDCCH), Physical downlink shared channel (PDSCH), Physical uplink control channel (PUCCH), Physical uplink shared channel (PUSCH), and Physical random-access channel (PRACH)

Herein, a signal, channel, and message (e.g., as in DL or UL signal, channel, and message) may be used interchangeably, but still consistent with this invention.

Herein, ‘RS’ may be interchangeably used with one or more of ‘RS resource’, ‘RS resource set’, ‘RS port’ and ‘RS port group’.

Herein, ‘RS’ may be interchangeably used with one or more of ‘SSB’, ‘CSI-RS’, ‘SRS’, ‘DM-RS’, ‘TRS’, ‘PRS’, and ‘PTRS’.

Herein, the terms ‘time instance’, ‘slot’, ‘symbol’, and ‘subframe’ may be used interchangeably.

Herein, the terms ‘SSB’, ‘SS/PBCH block’, ‘PSS’, ‘SSS’, ‘PBCH’, and ‘MIB’ may be used interchangeably.

The present principles for beam resources prediction may be used for beam resources belonging to a single or multiple cells as well as single or multiple TRPs.

Herein, ‘CSI reporting’ may be interchangeably used with ‘CSI measurement’, ‘beam reporting’ and ‘beam measurement’.

Herein, a ‘RS resource set’ may be interchangeably used with a ‘beam group’.

One or more thresholds (i.e., set values) in this invention may be based on one or more of predefined values, semi-statistically configured values (e.g., RRC), and dynamically indicated values (e.g., MAC CE and/or DCI).

Herein, ‘transmission beam’ may be interchangeably used with ‘transmitted beam’, ‘measured beam’, ‘transmitted RS’, ‘transmission RS’, ‘measured RS’, ‘mesurement RS’, ‘Set A’, ‘Type A RS’ and ‘Type IRS’.

Herein, ‘estimation beam’ may be interchangeably used with ‘estimated beam’, ‘predicted beam’, ‘predicted RS’, ‘prediction RS’, ‘estimated RS’, ‘estimation RS’, ‘Set B’, ‘Type BRS’ and ‘Type II RS’.

Herein, a ‘beam ID’ may be interchangeably used with a ‘beam pair ID’.

RS configuration for beam failure monitoring and new candidate beams. In at least one embodiment, a UE may support different configurations for transmission beams and estimation beams. For example, the configurations may be based on one or more of, each of which will be described in the following, Support of measurement type configuration, Supporting different RS resource sets, Support of different QCL configurations, Supporting beam IDs for estimation beams and RS resource indices for transmission beams, and Supporting assistance information for estimation beams with one or more reference RSs.

Support of measurement type configuration. For example, each resource may be configured with a type of RS (e.g., transmission beam or estimation beam). The UE may determine whether a RS is a transmission beam or an estimation beam based on the type of RS.

Supporting different RS resource sets. For example, the UE may be configured with two RS resource sets i.e., one for transmission beams (e.g., Set B) and another for estimation beams (e.g., Set A). Each RS resource set may be configured with a measurement type (e.g., transmission beam or estimation beam). Each RS resource may be configured with an associated RS resource set ID. The UE may determine whether a RS is a transmission beam or an estimation beam based on an associated RS resource set. For example, if the associated RS resource set is configured as transmission beams, the UE may determine the RS as a transmission beam. If the associated RS resource set is configured as estimation beams, the UE may determine the RS as an estimation beam.

Support of different QCL configurations. In embodiments, a first RS configuration for transmission beams may be based on a beam ID (e.g., CSI-RS resource ID) and QCL Info (QCL Type-D) for transmission beams and only a beam ID (without QCL) for estimation beams. The UE may determine whether a RS is a transmission beam or an estimation beam based on a configured QCL configurations. For example, if the configured QCL information is one QCL Type-D RS and a resource ID, then the UE may determine a transmission beam. If the configured QCL information includes a resource ID, but does not include QCL information (e.g., QCL Type-D RS), the UE may determine an estimation beam. Supporting a beam ID (e.g., CSI-RS resource ID) and a QCL Info (QCL Type-D) for transmission beams and a beam ID and one or more adjacent RS resources to identify beam characteristics for estimation beams. The UE may determine whether a RS is a transmission beam or an estimation beam based on configured QCL configurations. For example, if the configured QCL information is one QCL Type-D RS and a resource ID, then the UE may determine a transmission beam. If the configured QCL information includes a resource ID and two or more QCL information (e.g., two or more QCL Type-D RSs), the UE may determine an estimation beam.

Supporting beam IDs for estimation beams and RS resource indices for transmission beams. In embodiments, the UE may be configured with a first type of beam IDs (e.g., RS resource ID) for transmission beams and a second type beam IDs (e.g., logical beam ID) for estimation beams). The UE may determine whether a RS is a transmission beam or an estimation beam based on a configured beam ID type. For example, if the RS is configured with the first type of beam ID (e.g., RS resource ID), the UE may determine the RS as a transmission beam. If the RS is configured with the second type of beam ID (e.g., logical beam ID), the UE may determine the RS as an estimation beam.

Supporting assistance information for estimation beams with one or more reference RSs. In embodiments, the UE may be configured with one or more reference RSs and assistance information for estimation beams. For example, the UE may be configured with a single reference RS with one or more differential angles (e.g., delta angles). The UE may determine angles of a RS based on the differential angles and the reference RS. For example, horizontal angle=delta_h angle+horizontal angle of the reference RS, vertical angle=delta_y angle+vertical angle of the reference RS. For example, the UE may be configured with two or more reference RSs with one or more differential angles (e.g., delta angles). The UE may determine angles of a RS based on the differential angles and the reference RSs. E.g., horizontal angle=delta 1_h angle+horizontal angle of a first reference RS=delta2_h angle+horizontal angle of a second reference RS, vertical angle=deltal_y angle+vertical angle of the first reference RS=delta2_y angle+vertical angle of the second reference RS. The UE may determine whether a RS is a transmission beam or an estimation beam based on configured assistance information and/or reference RSs. For example, if the RS is configured with assistance information and/or one or more reference RSs, the UE may determine the RS as an estimation beam. If the RS is configured without assistance information and/or reference RSs, the UE may determine the RS as a transmission beam.

In embodiments, a UE may determine a beam ID (e.g., a logical beam ID) based on one or more of explicit configuration, determining beam IDs based on provided beam directions, and determining beam pair IDs.

Explicit configuration. In embodiments, the UE may receive a configuration of beam ID for each RS resource or each beam.

Determining beam IDs based on provided beam directions (e.g., beam ID 0=lowest angle). In embodiments, the UE may be configured with one or more of the following beam information for transmission beams and/or estimation beams: Number of transmission beams (the UE may receive one configuration for each of horizontal/vertical domains; the UE may indicate one configuration (e.g., via UE capability) for each of horizontal/vertical domains), Number of estimation beams (the UE may receive information indicative of one configuration for each of horizontal/vertical domains; the UE may indicate one configuration (e.g., via UE capability) for each of horizontal/vertical domains); Coverage of transmission beams (e.g., angular coverage such as 120 degrees); Coverage of estimation beams (e.g., angular coverage such as 60 degrees); Position/Center/Direction of transmission beams (e.g., 0 degree); Position/Center/Direction of estimation beams (e.g., 0 degree); Granularity of transmission beams, e.g., 3 degrees, (the UE may receive one configuration for each of horizontal/vertical domains; the UE may indicate one configuration (e.g., via UE capability) for each of horizontal/vertical domain); Granularity of estimation beams, e.g., 12 degrees, (the UE may receive one configuration for each of horizontal/vertical domains; the UE may indicate one configuration (e.g., via UE capability) for each of horizontal/vertical domains; UE panel related information (Number of UE panels, Position/Center/Direction of UE panels); Number of gNB TRPs and/or panels (Number of gNB TRPs and/or panels, Position/Center/Direction of gNB TRPs and/or panels).

Based on the configuration and/or the predefined rules, the UE may determine required information of transmission/estimation beams.

In embodiments, the UE may determine number of transmission beams and/or estimation beams based on the configured beam information. For example, the UE may divide the indicated coverage (e.g., 120 degrees) of transmission/estimation beams into granularity angle (e.g., 10 degrees) of transmission/estimation beams to determine number of transmission beams and/or estimation beams (e.g., 12). The UE may measure and/or transmit transmission/estimation beams based on the determined number of transmission beams and/or estimation beams.

In embodiments, the UE may determine direction/position/granularity of transmission beams and/or estimation beams based on the configured beam information. For example, the UE may divide the indicated coverage (e.g., 120 degrees) into the number of transmission/estimation beams (e.g., 12 beams) to determine position of estimation beams (e.g., 5, 15, 25, . . . , 115 degrees).

Determining beam pair IDs. In embodiments, the UE may determine beam pair IDs based on beam IDs. For example, the following equations may be used. Beam pair ID=TX beam ID*# of RX beams+RX beam ID. Beam pair ID=RX beam ID*# of TX beams+TX beam ID.

### Joint BFR Based on Explicit Configuration of Estimation Beams and Measurement Beams

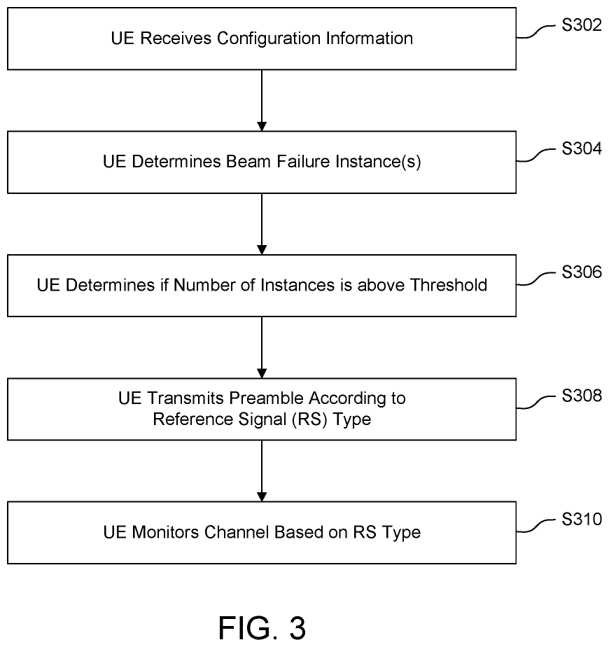

Referring to FIG. 3, in an embodiment of the present principles, a UE uses a different quality for beam failure detection based on the beam type of a RS (e.g., hypothetical PDCCH BLER for estimation beams and RSRP for transmission beams), prioritizes transmission beams for new beam selection (e.g., adding RSRP values) and indicates a determined RS type for the new beam selection.

In step S302, the UE receives configuration information including one or more of Beam failure detection (BFD) RSs, one or more new candidate beam (NCB) RSs, a first threshold, a second threshold, a third threshold, a delta value, a first PRACH resource, a second PRACH resource, a first CORESET/SS and a second CORESET/SS. A RS may be of a first RS type (e.g., transmission beams) or a second RS type (e.g., estimation beams).

In step S304, the UE can determine a beam failure instance if every configured BFD RSs fails. For the first RS type, beam failure is determined for a BFD RS if a first type of measured parameter (e.g., RSRP) of the RS is lower than the first threshold. For the second RS type, beam failure is determined for a BFD RS if a second type of predicted parameter (e.g., hypothetical PDCCH BLER) of the RS is lower than the second threshold.

In case the number of beam failure instances within a first time window is greater than the third threshold, in step S306, the UE can begin beam failure recovery and determine a RS (e.g., the best) from the one or more NCB RSs based on a third type (e.g., RSRP) of measured parameters of the one or more NCB RSs. For a NCB RS of the first RS type, the UE determines the third type of measured parameter+the delta value of the NCB RS. For a NCB RS of the second RS type, the UE determines the third type of predicted parameter based on a predicted value of the NCB RS.

In step S308, the UE transmits a PRACH based on a determined RS type. If the determined RS is of the first RS type, the UE transmits the PRACH in the first PRACH resource. If the determined RS is of the second RS type, the UE transmits the PRACH in the second PRACH resource.

In step S310, the UE monitors for a PDCCH based on a determined RS type. If the determined RS is the first RS type, the UE monitors for a PDCCH in the first CORESET/SS. If the determined RS is the second RS type, the UE monitors for a PDCCH in the second CORESET/SS.

The UE can support beam failure recovery by jointly utilizing transmission RSs and estimation RSs.

The UE can receive information corresponding to one or more configurations which may be used for beam failure recovery:

The UE may for example be configured with one or more of beam failure detection (BFD) RSs (e.g., q̅₀). Each BFD RS may be a transmission RS or an estimation RS. The configuration of BFD-RSs may be based on explicit configuration by a gNB. The configuration of the BFD-RSs may be based on implicit configuration. For example, if the UE does not receive explicit configuration of the BFD-RSs, the UE may determine the one or more BFD-RSs based on one or more RSs with QCL Type-D in configured TCI states for PDCCH reception (e.g., in configured CORESETs/SearchSpaces).

The UE may be configured with one or more counters and one or more maximum numbers of the one or more counters. The counters may for example be BFD counters and thresholds for the BFD counters, Beam reporting counters and thresholds for the beam reporting counters, and Preamble power ramping counter and thresholds for preamble power ramping counter.

In case a set of counters (e.g., one or more of BFD counter, beam reporting counter and preamble power ramping counter) and thresholds are configured, the set of counters and thresholds may be used for both estimation beams and transmission beams. If multiple sets of counters (e.g., one or more of BFD counter, beam reporting counter and preamble power ramping counter) and thresholds are configured, a first set of counters and thresholds may be for transmission beams and a second set of counters and thresholds may be for estimation beams. The number of configured counters and number of configured thresholds for each set may be the same.

The UE may be configured with one or more timers, for example BFI timers, BFD timers, and BFR timers.

In case a set of timers (e.g., one or more of BFI timer, BFD timer and BFR timer) is configured, the set of timers may be used for both transmission beams and estimation beams. If multiple sets of timers are configured, a first set of timers may be used for transmission beams and a second set of timers may be used for estimation beams.

The UE may be configured with one or more sets of new candidate beam (NCB) RSs (e.g., q̅₁). The configuration of BFD-RSs may be based on explicit configuration by a gNB. Each of the one or more of BFD RSs may be a transmission RS or an estimation RS. Each RS of NCB-RSs may be associated with one or more uplink resources (e.g., PRACH (resource and/or sequence), PUCCH, PUSCH, and/or SRS).

The UE may be configured with one or more uplink resources(S) for new candidate beam indication, wherein S is one or more uplink resources to indicate new candidate beam. Each uplink resource may be associated with each NCB-RS. Each uplink resource may be associated with NCB-RS type. For example, a first uplink resource may be associated with transmission beams and a second uplink resource may be associated with estimation beams.

The UE may be configured with CORESETs and/or search spaces (C) for receiving one or more confirmation random access response of BFR, wherein Ci is a set of search spaces to receive random access response for BFR. Each CORESET/search space may be associated with NCB-RS type. For example, a first CORESET/search space may be associated with transmission beams and a second CORESET/search space may be associated with estimation beams.

The UE may determine a beam failure instance if a number of failed BFD RSs is greater than a threshold (e.g., all configured BFD RSs fail). BFD RS failure may for example be defined based on application of a same set of measurement parameters and thresholds (e.g., the UE may determine beam failure if a measured parameter (e.g., hypothetical PDCCH BLER or RSRP) of the RS is lower than a threshold). BFD RS failure may also be defined based on application of different sets of measurement parameters and thresholds (e.g., the UE may apply different sets of parameter and thresholds based on a RS type of a RS. For example, for the first RS type, the UE may determine beam failure for a BFD RS if a first type of measured parameter (e.g., hypothetical PDCCH BLER) of the RS is lower than a first threshold. For the second RS type, the UE may determine beam failure for the BFD RS if a second type of predicted parameter (e.g., RSRP) of the RS is lower than the second threshold).

The UE may determine beam failure recovery procedure if a number of detected beam failure instances within a time window is greater than a corresponding threshold. For example, the UE may initiate a procedure for new beam selection. The UE may determine one or more RSs from the one or more NCB RSs based on one or more of measured parameters.

The UE may determine one or more RSs based on a same set of measurement parameters and threshold. For example, the UE may measure a same type of parameter (e.g., RSRP) for the one or more NCB RSs. if the measured parameter of the one or more NCB RSs is higher than a threshold, the UE may determine one or more RSs (e.g., with top qualities based on the measured parameter). The UE may apply an offset to the measured parameter based on a RS type. For example, the UE may determine the measured parameter as a final value for a first RS type (e.g., transmission beams). The UE may determine the measured parameter—a delta value as a final value for a second RS type (e.g., estimation beams). The UE may also apply an offset to the measured parameter based on a RS type. For example, the UE may determine the measured parameter+a delta value as a final value for a first RS type (e.g., transmission beams). The UE may determine the measured parameter as a final value for a second RS type (e.g., estimation beams).

The UE may apply different sets of parameter and thresholds based on a RS type of a RS. For example, the UE may measure different types of measurement parameters (e.g., measured RSRP or predicted RSRP) based on a type of a RS of the one or more NCB RSs. In case the measured parameter of the RS is higher than a corresponding threshold, the UE may determine one or more RSs based on the determined measured parameters (e.g., with top qualities based on the measured parameter).

For example, for the first RS type, the UE may determine one or more RSs from the one or more NCB RSs based on a first set of measurement parameters (e.g., measured RSRP) and thresholds. For the second RS type, the UE may determine one or more RSs from the one or more NCB RSs based on a second set of measurement parameters (e.g., measured RSRP) and thresholds.

The UE may transmit one or more uplink channels and/or signals for beam failure incident indication and/or new candidate beam indication. The uplink channels and/or signals may be one or more of MAC-CE, RRC, PRACH (e.g., RACH msg 1, msg 3, msg A), PUSCH, PUCCH, PUSCH DM-RS, SR, SRS, and SR-like signal, wherein SR-like signal may be an uplink channel which may be reserved periodically.

The UE may transmit one or more uplink channels based on a same set of uplink resource configurations. For example, regardless of a RS type of one or more determined NCB RSs, the UE may transmit the one or more uplink channels based on the same set of uplink resource configurations (e.g., with a same uplink sequence and/or in a same uplink resource).

The UE may transmit one or more uplink channels based on different sets of uplink resource configurations. For example, based on a RS type of one or more determined NCB RSs, the UE may determine a different uplink resource configuration for transmitting the one or more uplink channels. For example, for the first RS type, the UE may transmit one or more uplink channels based on a first set of uplink resource configuration (e.g., with a first uplink sequence and/or in a first uplink resource). For the second RS type, the UE may transmit one or more uplink channels based on a second set of uplink resource configuration (e.g., with a second uplink sequence and/or in a second uplink resource).

The UE may receive one or more downlink channels and/or signals for a confirmation for the beam failure incident indication and/or the new candidate beam indication (e.g., from a gNB). The downlink channels and/or signals may be one or more of PDCCH, PDSCH, MAC CE, RRC, PDCCH DM-RS, PDSCH DM-RS, CSI-RS, SSB, TRS (e.g., CSI-RS for tracking), and PT-RS. The downlink resources may be based on one or more of the following:

The UE may receive one or more downlink channels based on a same set of uplink resource configurations. For example, regardless of a RS type of one or more indicated NCB RSs, the UE may receive the one or more downlink channels based on the same set of downlink resource configurations (e.g., with a same CORESET/SearchSpace/time and frequency resources).

The UE may receive one or more downlink channels based on different sets of downlink resource configurations. For example, based on a RS type of one or more indicated NCB RSs, the UE may determine a different downlink resource configuration for receiving the one or more downlink channels. For example, for the first RS type, the UE may receive one or more downlink channels based on a first set of downlink resource configuration (e.g., with a first set of CORESET/SearchSpace/time and frequency resources). For the second RS type, the UE may receive one or more downlink channels based on a second set of downlink resource configuration (e.g., with a second set of CORESET/SearchSpace/time and frequency resources).

As can be seen, a Wireless Transfer/Receive Unit, WTRU, can determine at least one beam failure, wherein beam failure is determined based on a measured value for a first type of beam and on an estimated value for a second type of beam, upon determining a number of beam failures: determine, based on a parameter, a determined candidate beam among a plurality of candidate beams, wherein the parameter is based on a measured parameter for a candidate beam of the first type and the parameter is predicted for a candidate beam of the second type, transmit a message, wherein the message is transmitted on a first resource in case the determined candidate beam is of the first type and on a second resource in case the determined candidate beam is of the second type, and monitor, using a resource set or signal based on the type of determined candidate beam, for a response.

### Separate BFR Based on Estimation Beams and Measurement Beams

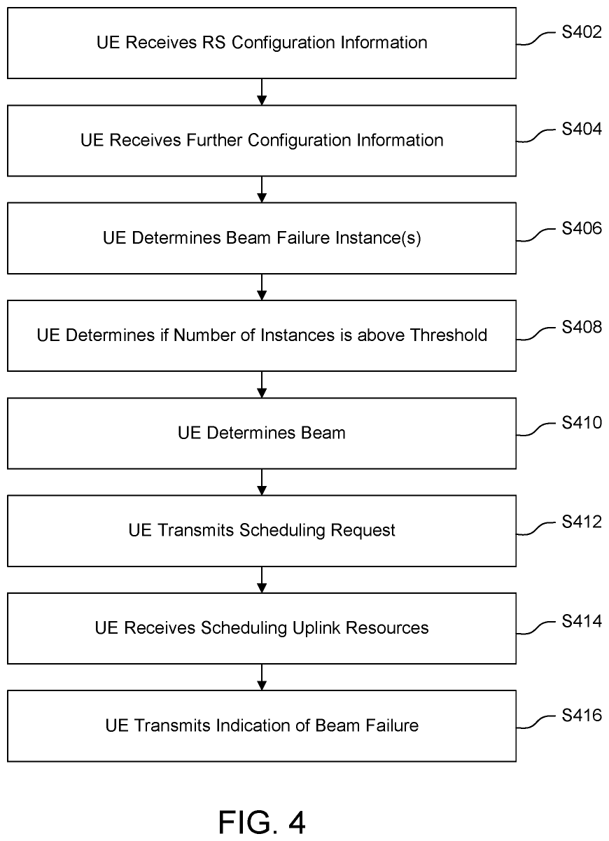

Referring to FIG. 4, in an embodiment of the present principles, a UE monitors and/or selects based on a separate set of RSs for transmission beams and estimation beams. If the UE detects beam failure, the UE indicates one or more failed sets to a gNB (e.g., the gNB it is served by).

In step S402, the UE receives first configuration information indicative of one or more RSs for a first BFD RS set and one or more RSs for a first NCB RS set with a first RS type and second configuration information indicative of one or more RSs for a second BFD RS set and one or more RSs for a second NCB RS set with a second RS type.

In step S404, the UE receives third configuration information indicative of a first threshold, a second threshold, a third threshold, a fourth threshold, a PUCCH resource for scheduling request and a CORESET.

In step S406, the UE determines one or more beam failure instances. The UE can determine a beam failure instance for the first BFD RS set if all RSs in the set fails (e.g., based on hypothetical PDCCH BLER), wherein an RS failure instance is determined in case a measured quality of the RS is lower than the first threshold. The UE can also determine a beam failure instance for the second BFD RS set if all RSs in the set fails (e.g., based on hypothetical PDCCH BLER), wherein an RS failure instance is determined if predicted quality of the RS is lower than the second threshold.

In step S408, the UE determines beam failure if the number of determined beam failure instances for the first BFD RS set is greater than a third threshold and/or the number of determined beam failure instances for the second BFD RS set is greater than a fourth threshold.

In step S410, the UE determines a beam (e.g., the best beam) for a failed BFD RS set based on measured/predicted qualities of an NCB RS set associated with the failed RS set.

In step S412, the UE transmits a scheduling request via the PUCCH resource for MAC CE.

In step S414, the UE receives PDCCH scheduling uplink resources for MAC CE via the CORESET.

In step S416, the UE transmits MAC CE indicating a type of beam failure (i.e., beam failure detected on the first BFD RS set, beam failure detected on the second BFD RS set or beam failure detected on both sets).

The UE may be configured with one or more sets of beam failure detection (BFD) RSs (e.g., q̅_{0,i}).

For example, two RS sets may be configured for a mode of operation and the first set of BFD-RS (e.g., q̅_{0,1}) may be associated with transmission beams and the second set of BFD-RS (e.g., q̅_{0,2}) may be associated with estimation beams.

The BFD-RS configuration may be based on implicit configuration. For example, if the UE does not receive explicit configuration of the one or more sets of BFD-RS, the UE may determine the one or more sets of BFD-RSs based on one or more RSs with QCL Type-D in configured TCI states for PDCCH reception. For example, the UE may determine one or more BFD-RS sets based on explicit/implicit CORESET/search space group configuration/indication. The CORESET/search space group configuration/indication may be based on one or more of explicit or implicit configuration/indication.

For explicit configuration/indication of the CORESET/search space group ID, the UE may be configured with one or more CORESETs with CORESET group ID. Based on the group ID, the UE may determine a CORESET group for the one or more CORESETs. For example, if the UE is configured with a first CORESET with a first CORESET group ID (e.g., for transmission beams) and a second CORESET with a second CORESET group ID (e.g., for estimation beams), then the UE may determine the first CORESET as the first CORESET group and the second CORESET as the second CORESET group. The UE may receive a group ID in a TCI state configuration instead of CORESET configuration.

Implicit configuration/indication may for example be used for Configured RS for each CORESET/search space, CORESET/search space type or ID configuration (e.g., CORESET/search space ID and/or TCI state ID).

For configured RS for each CORESET/search space, the UE may be configured with one or more CORESETs and one or more QCL reference RS (e.g., for QCL Type-D) may be configured for each CORESET/search space. The UE may determine a BFD-RS set based on the configured QCL reference RS. For example, if the configured QCL reference RS is a first type (e.g., transmission beams), the UE may determine the reference RS as a RS of a first BFD RS set. If the configured QCL reference RS is a second type (e.g., transmission beams), the UE may determine the reference RS as a RS of a second BFD RS set.

For CORESET/search space type, the UE may be configured with one or more CORESETs with CORESET type. Based on the CORESET type, the UE may determine a CORESET group. For example, if the UE is configured with a first CORESET with a first CORESET type (e.g., joint TCI state indication), the UE may determine the first CORESET as a first CORESET group. If the UE is configured with a second CORESET with a second CORESET type (e.g., PDSCH/PUSCH scheduling), the UE may determine the second CORESET as a second CORESET group.

For ID configuration (e.g., CORESET/search space ID and/or TCI state ID), the UE may determine the CORESET group based on a ID. For example, if an associated ID of a first CORESET is smaller than (or equal to) a threshold, the UE may determine the first CORESET as a first CORESET group. If the associated ID of the first CORESET is larger than the threshold, the UE may determine the first CORESET as a second CORESET group.

The UE may be configured with one or more sets of new candidate beam (NCB) RSs (e.g., q̅_{1,i}), wherein q̅_{1,i} may be the set of new candidate beam RSs associated with one of transmission beams or estimation beams. For example, a first NCB RS set may be associated with transmission beams and a second NCB RS set may be associated with estimation beams. For example, NCB-RSs in all NCB-RS sets may be associated with one uplink resources. For example, each NCB-RS in the set may be associated with one or more uplink resources (e.g., PRACH, PUCCH, PUSCH, and/or SRS)

The UE may be configured with one or more sets of uplink resources (Sᵢ) for new candidate beam indication, wherein Sᵢ is a set of uplink resources to indicate new candidate beams for one of transmission beams or estimation beams. For example, S₀ may be associated with transmission beams and S₁ may be associated with estimation beams.

The UE may be configured with one or more sets of search spaces (Cᵢ) for receiving one or more confirmation random access response of BFR, wherein Cᵢ is a set of search spaces to receive random access response for BFR for one of transmission beams or estimation beams. For example, C₀ may be associated with transmission beams and C₁ may be associated with estimation beams.

The UE can determine one or more new candidate beams (q_{new,i}) and each new candidate beam may be associated with a different cell, wherein q_{new,i} is determined new candidate beam (or beam index) for one of transmission beams or estimation beams. For example, a first new candidate beam (q_{new,1}) may be selected from the new candidate beam RS set associated with transmission beams and a second new candidate beam (q_{new,2}) may be selected from the new candidate beam RS set associated with estimation beams.

The UE may be configured with a set of transmitted beams and a set of predicted beams. The transmitted beams may be associated with Set B or a configuration thereof. For example, the UE may be configured to predict RSRP of a first beam (i.e., a predicted beam) based on measured RSRP of a second beam (e.g., a transmitted beam). The terms ‘predicted beam’ and ‘skipped beam’ may be used interchangeably. The terms ‘transmitted beam’, ‘Set B beam’, and ‘measured beam’ may be used interchangeably. The term ‘beam’ may refer to ‘SSB beam’, ‘CSI-RS beam’, or both.

The UE can receive first configuration information of one or more RSs for a first BFD RS set and one or more RSs for a first NCB RS set with a first RS type and second configuration information of one or more RSs for a second BFD RS set and one or more RSs for a second NCB RS set with a second RS type. For example, the first configuration information may be associated with transmitted beam (i.e., measured beam/Set B beam) and second configuration information may be associated with skipped beam (i.e., predicted beam). For example, the first RS type may be associated with transmitted beam (i.e., measured beam/Set B beam) and second RS type may be associated with skipped beam (i.e., predicted beam).

For beam failure detection/recovery, the UE may be configured with a first threshold, a second threshold, a third threshold, and a fourth threshold. For example, the first threshold may be associated with beam failure instance determination for the first BFD RS set, the second threshold may be associated with beam failure instance determination for the second BFD RS set, the third threshold may be associated with beam failure detection for first BFD RS set, and the fourth threshold may be associated with beam failure detection for second BFD RS set.

The UE may be configured with a RACH resource for transmission of scheduling request associated with beam failure recovery. The UE may be configured with a first RACH resource and a second RACH resource for scheduling request associated with beam failure recovery. The UE may be configured with a PUCCH resource for transmission of scheduling request associated with beam failure recovery. The UE may be configured with a first PUCCH resource and a second PUCCH resource for scheduling request associated with beam failure recovery. The UE may be configured with CORESET for reception of UL grant for transmission of beam failure recovery request and/or reception of confirmation of beam failure recovery. The UE may be configured with a first CORESET and a second CORESET for reception of UL grant for transmission of beam failure recovery request and/or reception of confirmation of beam failure recovery.

The UE may be configured to perform a first beam failure detection procedure associated with a first BFD RS set. For example, the first BFD RS set may be associated with a transmitted beam (i.e., measured beam/Set B beam). The UE may be configured to assess the link quality of the RSs associated with the first BFD set against a first threshold. The UE may determine a beam failure instance for the first BFD RS set if all the RSs in the set fails. For example, the RS failure is determined if measured quality of the RS is lower than the first threshold. Possibly the threshold and the measured quality may be based on a hypothetical PDCCH BLER or RSRP.

The UE may be configured to perform a second beam failure detection procedure associated with a second BFD RS set. For example, the second BFD RS set may be associated with a predicted beam (i.e., skipped beam). The UE may be configured to assess the link quality of the RSs associated with the second BFD set against a second threshold. The UE may determine a beam failure instance for the second BFD RS set if all the RSs in the set fails. For example, the UE may determine a beam failure instance for the second BFD RS set if preconfigured number of RSs in the second BFD RS set fails. For example, the RS failure can be determined if the predicted quality of the RS is lower than the second threshold. The UE may derive the predicted quality of the RS based on measured quality of one or more RSs from the first BFD RS set. The threshold may be based on hypothetical PDCCH BLER. The determination may be based on a different hypothetical PDCCH BLER threshold compared to hypothetical PDCCH BLER threshold associated with first BFD RS set. RSRP-based thresholds may be applied instead of BLER thresholds.

The UE may be configured to detect/declare beam failure in case the number of beam failure instances for the first BFD RS set is greater than a third threshold. The UE may be configured to detect/declare beam failure in case the number of beam failure instances for the second BFD RS set is greater than a fourth threshold. The UE may be configured to detect/declare beam failure in case the number of beam failure instances for the first BFD RS set is greater than third threshold AND the number of beam failure instances for the second BFD RS set is greater than fourth threshold.

The UE may be configured with rules to determine the beam for beam recovery (e.g., the best beam) based on status of beam failure for the first BFD RS set and second BFD RS set. For example, the UE may be configured to determine the beam from the first NCB RS set if the beam failure is detected for the first BFD RS set and second BFD RS set. For example, the UE may be configured to determine the beam from the second NCB RS set if the beam failure is detected for the first BFD RS set and not the second BFD RS set. For example, the UE may be configured to determine the beam from the first NCB set if the beam failure is detected for the second BFD set and not the first BFD RS set.

The UE may be configured with rules to determine the beam for beam recovery based on status of beam quality associated the first NCB RS set associated with first RS type and second NCB RS set associated with second RS type—wherein the first RS type may be associated with transmitted beam (i.e., measured beam/Set B beam) and second RS type may be associated with skipped beam (i.e., predicted beam).

The UE may be configured to select the beam for a failed BFD RS set based on measured/predicted qualities of an NCB RS set associated with the failed RS set. The UE may be configured to select the beam for a failed BFD RS set based on measured/predicted qualities of an NCB RS set not associated with the failed RS set.

For example, upon beam failure in the first BFD RS set, the UE may be configured to select the beam for recovery from the first NCB RS set. For example, upon beam failure in the first BFD RS set, the UE may be configured to select the beam for recovery considering both the first NCB RS set and second NCB RS set. Possibly based on measured quality of beams from the first NCB RS set and predicted quality of beams from the second NCB RS set. For example, upon beam failure in the second BFD RS set, the UE may be configured to select the beam for recovery from the second NCB RS set, possibly based on the predicted quality of beams from the second NCB RS set. For example, upon beam failure in the second BFD RS set, the UE may be configured to select the beam for recovery considering both the first NCB RS set and second NCB RS set, possibly based on measured quality of beams from the first NCB RS set and predicted quality of beams from the second NCB RS set.

The UE may transmit a scheduling request via PUCCH resource configured for second BFD RS set and/or second NCB RS set, if the beam failure is determined for the second BFD RS set and not determined for first BFD RS set and if UL grant is not available. The UE may be configured to receive a PDCCH on a CORESET preconfigured for second BFD RS and/or second NCB RS set.

The UE may transmit one or more UL channels and signals (e.g., PRACH, PUCCH, PUSCH, MAC CE and SRS) indicating one or more of beam failure, the one or more RS sets on which the beam failure is detected (e.g., first, second or both) and a newly selected beam from the detected RS sets. In an example, the UE may explicitly indicate the detected RS sets (e.g., via MAC CE). For example, 0 may indicate beam failure detection from a first RS set (e.g., transmission RSs), 1 may indicate beam failure detection from a second RS set (e.g., estimation RSs) and 2 may indicate beam failure detection from both sets (e.g., transmission and estimation RSs). In another example, the UE may implicitly indicate the detected RS sets (e.g., via PUCCH and/or PRACH). For example, the UE may transmit the one or more UL channels and signals in a first UL resource and/or a first UL sequence if the beam failure is detected from a first set (e.g., transmission RSs). The UE may transmit the one or more UL channels and signals in a second UL resource and/or a second UL sequence for a second set (e.g., estimation RSs). The UE may transmit the one or more UL channels in both the first UL resource and/or sequence and the second UL resource and/or sequence if the beam failure is detected from both sets.

The UE may monitor PDCCH in the first CORESET/search space if the beam failure recovery request is associated with first BFD RS set, if the beam failure recovery request is associated with second BFD RS set, or if the beam failure recovery request is associated with both BFD RS sets.

### Joint BFR Based on Implicit Configuration of Estimation Beams and Measurement Beams

A UE may monitor the beam failure detection RS sets in active BWPs. The UE may further estimate the beam and/or radio link quality and report the out-of-sync and/or in-sync status. In an example, a UE may measure the radio link quality (L1-RSRP) for SSB(s) and/or CSI-RS(s) in a corresponding beam failure detection RS set. The UE may then compare the measurement with respective thresholds to determine, indicate, or detect if beam failure instance (BFI) has happened.

The UE may indicate, determine, or be configured with one or more beam failure detection (BFD) counters. As such, the UE may detect the beam failure by counting BFI indications. The UE may indicate, determine, or be configured with one or more of a BFI Counter (used for counting the number of BFIs, which is set to 0 initially and is incremented per BFI detection), BFI_Max_Count (a maximum value for the BFI_Counter; may trigger beam failure detection). BFD_Timer (a timer that is started with the first BFI detection). If the timer expires before the BFI Counter reaches the BFI_Max_Count, the beam failure detection procedure is stopped. These parameters are a non-limiting example of the parameters that may be used in beam failure detection.

In an example, if BFI has occurred, the UE starts, restarts or leaves a BFD_Timer running, and adds BFI_Counter by 1. If BFI_Counter reaches the BFI_Max_Count, the UE may trigger a BFD event and may initiate a beam failure recovery (BFR) procedure.

A UE may determine, indicate, or trigger a beam failure recovery based on the beam failure detection event. The UE may indicate, determine, or be configured with one or more of BFR_Timer (a timer started with a beam failure recovery procedure), RSRP_Threshold (threshold for RSRP used in beam failure recovery), candidateBeamRSList (a list of candidate beam reference signal indeces to be monitored, measured, and selected during the beam failure recovery), Power Ramping (parameters including for example power ramping step, and received preamble target power), and Random Access data (PRACH parameters for example including preamble index, SSB per RACH occasion, random access response window, PRACH configuration index, random access occasions and SSBs association mask index). These above parameters are a non-limiting example of the parameters that may be included in beam failure detection.

The UE may use, receive, and/or be configured with one or more sets of reference signals per BWP for monitoring, measuring, and selecting as the resources for the beam failure recovery. For example, the term q1 may be used for the beam failure recovery set. In another example, the terms q1,0 or q1,1 may be used as the beam failure recovery sets. The beam failure recovery sets (e.g., set q1, q1,0, or q1,1) may include one or more reference signals, wherein the reference signals may be CSI-RS resource configuration indices, SS/PBCH block (SSB) indices, and so forth. In an example, the reference signals included in beam failure recovery RS sets may be based on candidateBeamRSList, that is configured as part of BFR procedure.

A UE may initiate beam failure recovery based on random-access procedure. In an example, the UE may configure the random-access parameters, start the BFR_Timer, and apply the power ramping parameters. The UE may monitor and measure one or more of the reference signals from the candidateBeamRSList. The UE may determine if at least one of the SSBs has SS-RSRP above respective RSRP_Threshold amongst the SSBs in candidateBeamRSList, or at least one of the CSI-RSs has CSI-RSRP above respective RSRP_Threshold amongst the CSI-RSs in candidateBeamRSList. The UE may then select the respective reference signal as the new candidate beam (NCB) and/or random-access resource for BFR procedure. For example, the term q_new may be used to present the new selected beam and/or random-access resource. The UE may perform PRACH transmission in respective random-access resources and according to spatial relation with the periodic CSI-RS resource configuration or with SS/PBCH block associated and/or QCL-ed with index q_new.

The PRACH preamble transmission may be based on contention-free PRACH transmission that is subject to the UE being provided and/or configured with a preamble (e.g., index) for the PRACH transmission. For example, the UE may use a configured preamble and/or resource for PRACH transmission (e.g., via one or more of RRC, MAC CE and DCI). Based on the PRACH transmission, the UE may receive a PDSCH (e.g., Msg1) for random-access response. The PRACH preamble transmission may be based on contention-based PRACH transmission, in which the UE selects a (e.g., random) PRACH preamble (e.g., index) from a set of available preambles (e.g., indices) for the PRACH transmission. For example, the UE may select a preamble and/or PRACH resource randomly from a configured pool of preambles/PRACH resources and transmit PRACH in the selected preamble/PRACH resource (e.g., Msg1). Based on the transmitted PRACH, the UE may receive a PDCCH (e.g., scheduling a PDSCH for random access response) and a PDSCH (e.g., a random-access response) (e.g., within a random access response window). The random-access response may contain one or more of RA-preamble identifier, timing alignment information, initial uplink grant, and temporary C-RNTI. One PDSCH can carry RA responses to multiple UEs. If the UE receives the random-access response containing a random-access preamble identifier which is the same as the identifier contained in the transmitted RA preamble, the UE may transmit uplink scheduling information (e.g., Msg3). If the UE does not receive a response within the random-access response window or fails to verify the response, the UE may determine that the previous attempt was failed. In this case, if the number of random-access attempts (e.g., transmitting PRACH) is smaller than a threshold value (e.g., 10), the UE may transmit another PRACH. If the number of random-access attempts is larger than (or equal to) the threshold, the random access may fail. If the UE receives a PDCCH (e.g., Msg4) with C-RNTI or a UE contention resolution identity IE before expiration of a contention resolution timer (e.g., 4 ms), the UE may determine that the random-access procedure is successful and apply the received C-RNTI for future operation. If the contention resolution timer expires before receiving the PDCCH, the UE may perform the random-access procedure again. If the number of random-access procedure attempts is equal to (or larger than) a threshold (e.g., 10), the UE may assume that the random-access procedure failed.

A UE may determine, identify, or be configured with one or more CORESETs corresponding to the random-access procedure for the respective beam failure recovery. In an example, the UE may monitor PDCCH in a search space set for detection of a DCI format with respective CRC scrambled with a Radio Network Identifier (e.g., C-RNTI or MCS-C-RNTI). The UE may determine the same antenna port quasi-collocation parameters as the ones associated with index q_new for monitoring the PDCCH in a search space set and receiving the corresponding PDSCH.

If BFR_Timer has expired and beam failure recovery procedure has not been accomplished successfully, the UE may trigger a link failure detection and follow with link failure recovery (LFR) procedures.

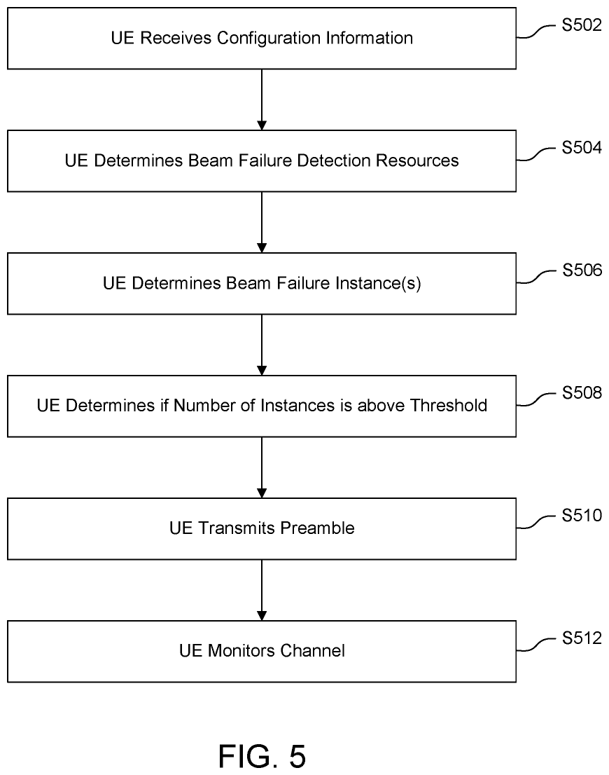

Referring to FIG. 5, in an embodiment, a UE dynamically determines a type of a quality parameter for beam failure detection for estimation beams (e.g., if PDCCH/PDSCH are measured, use DMRS and hypothetical PDCCH BLER; if not, use beam prediction and predicted RSRP). The UE determines a best new beam and applies a different PRACH transmission (e.g., contention-free for transmission beams and contention-based for estimation beams) for a new beam indication.

In step S502, the UE receives configuration information indicative of one or more CORESETs associated with one or more TCI states, one or more NCB RSs, a first threshold, a second threshold, a third threshold, a first time window, a contention-free PRACH resource and a contention-based PRACH resource. Each RS may be a first RS type (e.g., transmission beams) or a second RS type (e.g., estimation beams).

In step S504, the UE determines one or more BFD RSs and BFD RS types, based on configured RSs in the one or more TCI states.

In step S506, the UE determines a beam failure instance if all of the one or more BFD RSs fails. For the first RS type, the UE determines beam failure of a RS if measured quality (e.g., hypothetical PDCCH BLER) of the RS is lower than the first threshold. For the second RS type, if one or more PDCCHs/PDSCHs (e.g., in/by the one or more CORESETs associated with the RS) are transmitted within a first time window, the UE determines beam failure of the RS if measured quality (e.g., hypothetical PDCCH BLER) of DMRS of the one or more PDCCHs/PDSCHs is lower than the second threshold. For the second RS type, if no PDCCHs/PDSCHs are transmitted within a first time window, the UE determines beam failure of the RS if predicted quality (e.g., hypothetical PDCCH BLER) of the RS is lower than a second threshold.

If the number of beam failure instances within the first time window is greater than the third threshold, in step S508, the UE begins beam failure recovery and determines a RS (e.g., a best RS) from the one or more NCB RSs based on measured/predicted quality (e.g., RSRP) of the one or more NCB RSs.

In step S510, the UE transmits a PRACH in a PRACH resource associated with the determined best RS. If the UE determines the RS to be of the first RS type, the UE transmits a PRACH in the contention-free PRACH resource. If the UE determines the RS to be of the second RS type, the UE transmits a PRACH in the contention-based PRACH resource.

In step S512, the UE monitors for a PDCCH via a CORESET of the one or more CORESETs.

The UE may receive configuration information and be configured accordingly for beam failure recovery.

The UE may be configured with one or more of beam failure detection (BFD) RSs (e.g., q̅₀). Each BFD RSs may be a transmission RS or an estimation RS. The configuration of BFD-RSs may be based on explicit configuration by a gNB. The configuration of the BFD-RSs may be based on implicit configuration. For example, if the UE does not receive explicit configuration of the BFD-RSs, the UE may determine the one or more BFD-RSs based on one or more RSs with QCL Type-D in configured TCI states for PDCCH reception (e.g., in configured CORESETs/SearchSpaces).

The UE may be configured with one or more counters and one or more maximum numbers of the one or more counters, for example BFD counters and thresholds for the BFD counters, beam reporting counters and thresholds for the beam reporting counters, and preamble power ramping counter and thresholds for preamble power ramping counter The UE may be configured with one or more timers, for example BFI timers, BFD timers, and BFR timers.

The UE may be configured with one or more sets of new candidate beam (NCB) RSs (e.g., q̅₁). The configuration of BFD-RSs may be based on explicit configuration by a gNB. Each BFD RSs may be a transmission RS or an estimation RS. Each NCB-RSs may be associated with one or more uplink resources (e.g., PRACH (resource and/or sequence), PUCCH, PUSCH, and/or SRS).

The UE may be configured with one or more uplink resources(S) for new candidate beam indication, wherein S is one or more uplink resources to indicate new candidate beam(s). Each uplink resource may be associated with each NCB-RS.

The UE may be configured with CORESETs and/or search spaces (C) for receiving one or more confirmation random access responses of BFR, wherein Cᵢ is a set of search spaces to receive random access responses for BFR.

The UE may receive configuration information for one or more CORESETs associated with one or more TCI states for the beam failure detection. In an example, the UE may be configured and/or provided with one or more beam failure detection RS sets for a BWP. The beam failure detection RS sets for a BWP may be based on the reference signal resource configurations that the UE uses for monitoring PDCCH in the respective CORESETs as indicated by TCI-states.

The UE may be configured with the BFD reference signals that are of a first type, a second type, and so forth. In an example, the first type for the BFD reference signals may indicate that the reference signals are based on beams that are being transmitted; the second type for the BFD reference signals may indicate that the reference signals are based on estimation beams. The UE may determine one or more BFD RSs and BFD RS types, based on configured RSs in the one or more TCI states.

The UE may receive and/or be configured using one or more new candidate beam (NCB) reference signals (e.g., to be used during beam failure recovery procedure). The UE may be configured with the NCB reference signals that are of a first type, a second type, and so forth. In an example, the first type for the NCB reference signals may indicate that the reference signals are based on beams that are being transmitted; the second type for the NCB reference signals may indicate that the reference signals are based on estimation beams.

The UE may receive or be configured with a first threshold, a second threshold, a third threshold, a first time-window, a contention free PRACH resource and a contention based PRACH resource.

The UE may determine and/or indicate a beam failure instance (BFI) in case all of the one or more BFD reference signals have failed. The UE may determine different types for a BFD RS failure.

Type 1. In case of BFD RS of the first type, the UE determines the RS failure if one or more measured parameters (e.g., hypothetical PDCCH BLER) of respective BFD RS is lower than the first threshold.

Type 2. In case of BFD RS of the second type, the UE may receive one or more PDCCHs and/or PDSCHs (e.g., in and/or by the one or more CORESETs associated with the RS) are transmitted within the first time-window. As such, the UE may measure one or more parameters (e.g., hypothetical PDCCH BLER) based on the received PDCCHs and/or PDSCHs (e.g., based on DMRS). The UE may determine the BFD RS failure if one or more of the measured parameters of the one or more PDCCHs and/or PDSCHs is lower than the second threshold.

Type 3. In case of BFD RS of the second type, the UE may monitor to receive one or more PDCCHs and/or PDSCHs (e.g., in and/or by the one or more CORESETs associated with the RS). In case the UE does not receive any PDCCH and/or PDSCH within the first time-window, the UE may determine, calculate, and/or predict one or more parameters (e.g., hypothetical PDCCH BLER). The UE may determine the BFD RS failure if one or more of the predicted parameters is lower than the second threshold.

The UE may initiate a counter to count the number of beam failure instances within the first time-window. In case the number of beam failure instances within the first time-window is greater than the third threshold, the UE may begin a beam failure recovery procedure. The UE may monitor, detect, and/or measure one or more parameters (e.g., RSRP) for the determined and/or configured NCB reference signals of the first type. Alternatively, the UE may calculate, estimate, and/or predict one or more parameters (e.g., RSRP) for the determined and/or configured NCB reference signals of the second type. The UE may determine a best reference signal based on one or more measured and/or predicted parameters (e.g., RSRP) from the one or more NCB reference signals.

The UE may determine to initiate an initial access procedure (e.g., transmit a PRACH preamble) in PRACH time and/or frequency resources that are associated with the determined one or more reference signals (e.g., best reference signals). The UE may perform PRACH transmission in respective random-access resources and according to spatial relation (e.g., QCL-ed) with the determined best reference signal. The UE may determine to use a first type of PRACH preamble and/or PRACH resources (e.g., contention-free PRACH procedure), in case the determined one or more reference signals are of the first RS type. The UE may determine to use a second type of PRACH preamble and/or PRACH resources (e.g., contention-based PRACH procedure), in case the determined one or more reference signals are of the second RS type.

After PRACH preamble transmission, the UE may monitor and attempt to detect the random-access response (RAR) message (e.g., DCI with CRC scrambled with RA-RNTI) within the period of an RAR-window or limit. In an example, in case the UE determines to use the 4-step random access (RA) procedure, the UE may transmit a configured, selected, and/or determined PRACH preamble to the cell. After sending the PRACH preamble, the UE may monitor for a DL message (e.g., PDCCH) (e.g., indicating a RAR message) that may provide an UL grant. As such, the UE may send an UL message or indication (e.g., in a PUSCH) based on the UL grant. In another example, in case the UE determines to use the 2-step RA, the UE may transmit a message, e.g., MsgA, that may include a configured, selected, and/or determined PRACH preamble, and a PUSCH carrying a message to the cell. After sending MsgA, the UE may monitor for a DL message (e.g., PDCCH) (e.g., indicating a MsgB) that may include (e.g., at least) an RAR and may include contention resolution information.

As can be seen, a Wireless Transfer/Receive Unit, WTRU, can determine at least one beam failure, wherein beam failure is determined based on a measured value for a first type of beam and on at least one of a measured and an estimated value for a second type of beam, upon determining a number of beam failures: determine, based on a parameter, a determined candidate beam among a plurality of candidate beams, wherein the parameter is based on a measured parameter for a candidate beam of the first type and the parameter is predicted for a candidate beam of the second type, transmit, using a resource associated with the determined candidate beam, a message, and monitor, using a resource set or signal based on the type of determined candidate beam, for a response.

### Dynamic BFR Mode Activation/Deactivation

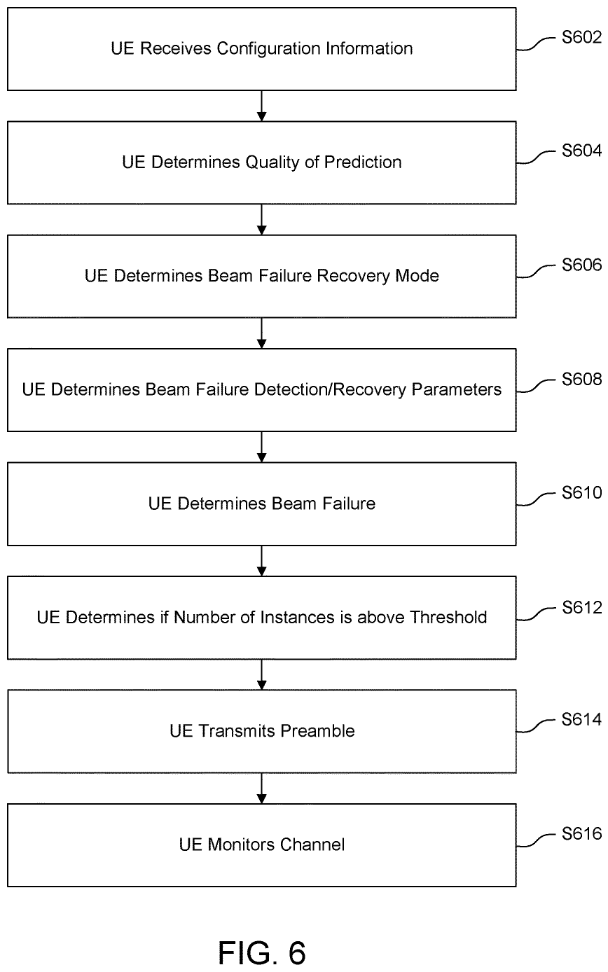

Referring to FIG. 6, in an embodiment, a UE determines a mode of operation for BFR (e.g., BFR based on only transmission beams or on joint BFR based on both transmission beams and estimation beams) based on a quality of prediction (e.g., RSRP difference or beam prediction accuracy).

In step S602, the UE receives configuration information indicative of one or more Beam failure detection (BFD) RSs, one or more new candidate beam (NCB) RSs, a first threshold, a second threshold, a third threshold, a fourth threshold, a fifth threshold, a sixth threshold, a PRACH resource, a first PRACH sequence, a second PRACH sequence, a first CORESET and a second CORESET. Each RS may be of a first RS type (e.g., transmission beams) or of a second RS type (e.g., estimation beams).

In step S604, the UE determines a quality of prediction based on the one or more BFD RSs and the one or more NCB RSs. The quality of prediction can be determined as the difference between predicted RSRP values and measured RSRP values (e.g., based on DMRS from PDCCH/PDSCH), or as beam prediction accuracy (e.g., predicted best beam vs actual best beam)

In step S606, the UE determines a BFR mode based on the quality of the prediction and a first threshold. In a first example, if the quality of the prediction is lower than the first threshold, the UE determines a first BFR mode (e.g., using only the first RS type for BFD and NCB (e.g., deactivates one or more RSs with the second type)). In a second example, if the quality of the prediction is greater than the first threshold, the UE determines a second BFR mode (e.g., using both the first RS type and the second RS type for BFD and NCB (e.g., activates all RSs configured for BFD and NCB)).

In step S608, the UE determines a set of Beam Failure Detection/Recovery parameters based on the quality of the prediction. In a first example, the UE determines to use one of the second threshold or third threshold based on the quality of prediction, for BFD RS failure detection of the second RS type. In a second example, the UE determines to use one of the fourth threshold or fifth threshold based on the quality of prediction, for detecting beam failure.

In step S610, the UE determines a beam failure instance if all of one or more activated BFD RSs fails. For the first RS type, the UE can determine beam failure for an RS, if measured quality of the RS is lower than the sixth threshold. For the second RS type, the UE can determine beam failure for an RS if measured quality of the RS is lower than one of the second threshold and the third threshold (determined by the UE).

In step S612, the UE detects beam failure based on the number of beam failure instances and the UE determined threshold. For example, if the number of beam failure instances within a time window is greater than one of the fourth threshold or fifth threshold (determined by the UE), the UE begins beam failure recovery and determines a RS from the activated NCB RSs based on measured qualities of the activated NCB RSs.

In step S614, the UE transmits a PRACH in the PRACH resource based on the determined BFR mode. If the UE determined the first BFR mode, the UE transmits the PRACH with the first PRACH sequence. If the UE determined the second BFR mode, the UE transmits the PRACH with the second PRACH sequence.

In step S616, the UE monitors the PDCCH based on the determined BFR mode. If the UE determined the first BFR mode, the UE monitors for PDCCH in the first CORESET. If the UE determined the second BFR mode, the UE monitors for PDCCH in the second CORESET.

A UE equipped with AI/ML capabilities for beam management (e.g., beam selection, beam failure detection (BFD), monitoring new candidate beams (NCB) RSs, etc. ,) may support different modes of operation for beam failure recover (BFR). The BFR procedure for a UE may associate with multiple steps including BFD, monitoring NCBs, indicating BF and selected NCB beam, receiving a confirmation for selected NCB from the gNB, and so forth. For example, in a first mode of operation the UE may perform BFR only based on transmission beams (beams transmitted by the gNB). In a second mode of operation, the UE may perform BFR based on both transmission beams and estimation beams (beams predicted by the AI/ML model).

A UE may be indicated or be configured with a mode of operation for a BFR by the gNB via RRC signaling, and/or MAC-CE indication, and/or DCI indication. Alternatively, the UE may select a mode of operation for a BFR and select BFR related procedures and parameters using one or more of the following methods.

The UE may receive information for configuration (e.g., via RRC signaling and/or MAC-CE indication, and/or DCI indication) of one or more BFD RSs, one or more new candidate beam (NCB) RSs, a first threshold, a second threshold, a third threshold, a fourth threshold, a first threshold, a sixth threshold, a seventh threshold, a eighth threshold, a PRACH resource, a first PRACH sequence, a second PRACH sequency, a first CORESET, a second CORESET from the gNB. The BFD RSs and NCB RSs the UE is configured by the gNB may be of a first RS type (e.g., transmission beam or transmission RS) or a second RS type (e.g., estimation beam or estimation RS).

The UE may be configured in different ways for beam failure recovery:

The UE may be configured with one or more of beam failure detection (BFD) RSs (e.g., q̅₀). Each BFD RSs may be a transmission RS or an estimation RS. The configuration of BFD-RSs may be based on explicit configuration by a gNB. The configuration of the BFD-RSs may be based on implicit configuration. For example, if the UE does not receive explicit configuration of the BFD-RSs, the UE may determine the one or more BFD-RSs based on one or more RSs with QCL Type-D in configured TCI states for PDCCH reception (e.g., in configured CORESETs/SearchSpaces).

The UE may be configured with one or more counters and one or more maximum numbers of the one or more counters, for example BFD counters and thresholds for the BFD counters, beam reporting counters and thresholds for the beam reporting counters, and a preamble power ramping counter and thresholds for the preamble power ramping counter.

In case a set of counters (e.g., one or more of BFD counter, beam reporting counter and preamble power ramping counter) and thresholds are configured, the set of counters and thresholds may be used for both estimation beams and transmission beams. If multiple sets of counters (e.g., one or more of BFD counter, beam reporting counter and preamble power ramping counter) and thresholds are configured, a first set of counters and thresholds may be for transmission beams and a second set of counters and thresholds may be for estimation beams. The number of configured counters and number of configured thresholds for each set may be the same.

The UE may be configured with one or more timers, for example BFI timers, BFD timers, and BFR timers.

In case a set of timers (e.g., one or more of BFI timer, BFD timer and BFR timer) is configured, the set of timers may be used for both transmission beams and estimation beams. If multiple sets of timers are configured, a first set of timers may be used for transmission beams and a second set of timers may be used for estimation beams.

The UE may be configured with one or more sets of new candidate beam (NCB) RSs (e.g., q̅₁). The configuration of BFD-RSs may be based on explicit configuration by a gNB. Each BFD RSs may be a transmission RS or an estimation RS. Each NCB-RSs may be associated with one or more uplink resources (e.g., PRACH (resource and/or sequence), PUCCH, PUSCH, and/or SRS).

The UE may be configured with one or more uplink resources(S) for new candidate beam indication, wherein S is one or more uplink resources to indicate new candidate beam. Each uplink resource may be associated with each NCB-RS. Each uplink resource may be associated with a NCB-RS type. For example, a first uplink resource may be associated with transmission beams and a second uplink resource may be associated with estimation beams.

The UE may be configured with CORESETs and/or search spaces (C) for receiving one or more confirmation random access response of BFR, wherein Cᵢ is a set of search spaces to receive random access response for BFR. Each CORESET/search space may be associated with a NCB-RS type. For example, a first CORESET/search space may be associated with transmission beams and a second CORESET/search space may be associated with estimation beams.

The UE may determine the quality of AI/ML-based beam estimations (quality of predictions) by using one or more BFD RSs and/or one or more NCB RSs. To this end, the UE may determine quality of predictions. For example, the UE may determine the difference between the predicted RSRP value and the measured RSRP values of one or more RSs. For example, the UE may estimate the RSRP of a predicted RS or a beam by measuring the RSRP of an associated DMRS (e.g., a DMRS from a PDCCH or PDSCH which has a same beam (e.g., QCL type-D) with the predicted RS). In a second example, the UE may determine the quality of the beam predictions by comparing the success (or failure) of the AI/ML model to rank the beams based on the beam quality (e.g., predicted best k beams vs measured best k beams).

The UE may determine a mode of operation for BFR based on the quality of predictions by the AI/ML model and the first threshold. For example, if the quality of the beam predictions is lower than the first threshold, the UE may determine a first mode of operation for BFR (e.g., using only one or more RSs with the first RS type (e.g., for BFD RSs and/or as NCBs RSs). To this end, the UE may deactivate or invalidate one or more RSs with the second RS type (e.g., BFD RSs and/or NCB RSs) if the quality of beam predictions is lower than the first threshold. If the quality of the beam predictions is greater than or equal to the first threshold, the UE may determine a second mode of operation for BFR (e.g., using both the first RS type and the second RS type for BFD and/or as NCBs). To this end, the UE may activate or validate all RSs configured for BFD and/or as NCBs if the quality of beam predictions is greater than the first threshold.

The UE may determine one or more parameters associated with BFR based on the quality of the beam predictions.

A first parameter is threshold on beam quality (e.g., hypothetical BLER) for BFD RS to determine a beam failure instance (BFI). For example, the UE may determine threshold on beam quality for the BFD RSs to determine a BFI based on the quality of the beam predictions. In an example configuration, the UE may determine to use the second threshold as the threshold on a quality (e.g., hypothetical PDCCH BLER) for BFI determination if the quality of the beam predictions is below a preconfigured threshold by the gNB (e.g., preconfigured via RRC signaling and/or MAC-CE indication, and/or DCI indication). The UE may determine to use the third threshold as the threshold for quality (e.g., hypothetical BLER) for BFI determination if the quality of the beam predictions is greater than or equal to the threshold preconfigured by the gNB.

A second parameter is threshold associated with beam failure determination. For example, the UE may determine the number of detected BFIs (e.g., beamFailureInstanceMaxCount) required within a configured time window (e.g., beamFailureDetectionTimer) to declare a beam failure based on the quality of the beam predictions. In an example configuration, the UE may select fourth threshold as the beamFailureInstanceMaxCount if the quality of the beam predictions is below a threshold preconfigured by the gNB (e.g., via RRC configuration, and/or MAC-CE indiaiton, and/or DCI indication). The UE may select a fifth threshold as the beamFailureInstanceMaxCount if the quality of the beam predictions is greater than or equal to the threshold preconfigured by the gNB.

A third parameter is threshold quality (e.g., threshold RSRP) for a NCB to be considered as a potential new beam (e.g., rsrp-ThresholdSSB). For example, the UE may determine to use the sixth threshold as rsrp-ThresholdSSB if quality of the beam predictions is below a preconfigured threshold by the gNB (e.g., via RRC signalig and/or MAC-CE indication, and/or DCI indication). The UE may determine to use the seventh threshold as rsrp-ThresholdSSB if the quality of the beam predictions is greater than or equal to the threshold preconfigured by the gNB. The UE may determine the rsrp-ThresholdSSB for a NCB to be considered as a potential new beam based on quality of the beam predictions only for the second RS type NCBs or for all NCBs.

A fourth parameter is maximum values associated with one or more timers related to BFR. For example, the UE may select first maximum value for a timer if the quality of the beam predictions is below a threshold preconfigured by the gNB (e.g., via RRC configuration, and/or MAC-CE indiaiton, and/or DCI indication). The UE may select a second maximum value for a timer if the quality of the beam predictions is greater than or equal to the threshold preconfigured by the gNB. The first and the second maximum values on the timers may be configured by the gNB via RRC signaling, and/or MAC-CE indication, and/or DCI indication. The timers may include BeamFailureRecoveryTimer, the timer associated with CFRA for BFR. Upon expiration of the BeamFailureRecoveryTimer, the UE does not use CFRA for BFR. The timers may also include BeamFailureDetectionTimer, the timer associated with the beam failure instance counter. Upon expiration of the BeamFailureDetectionTimer, the beam failure instance counter is reset.

A fifth parameter is step size associated with preamble transmit power ramping up procedure (e.g., powerRampingStep), and maximum powers associated with preamble transmission (e.g., preambleTransMax) indicating a selected new beam (e.g., preamble transmission in CFRA for BFR). For example, the UE may use a first step size for powerRampingStep if the quality of the beam predictions is below a threshold preconfigured by the gNB (e.g., via RRC configuration, and/or MAC-CE indication, and/or DCI indication). The UE may select a second step size for powerRampingStep if the quality of the beam predictions is greater than or equal to the threshold preconfigured by the gNB. The first and the second step sizes for powerRampingStep may be configured by the gNB via RRC configuration, and/or MAC-CE indication, and/or DCI indication.

The UE may determine beam failure instances when one or more activated BFD RSs fails. To determine the failure of a BFD RS, the UE may compare the quality of each beam (e.g., RSRP, hypothetical BLER) with different determined thresholds based on the type of RS. For example, the UE may determine a beam failure for a first RS type BFD RS, if the measured quality of the RS (e.g., RSRP, hypothetical BLER) is lower than the eighth threshold. The UE may determine beam failure for a second RS type BFD RS, if the estimated quality of the RS is lower than the second threshold or the third threshold. The UE may determine the second or the third threshold to be used to determine beam failure for the second RS type BFD RS based on the quality of beam predictions.

The UE may determine beam failure for the UE based on the number of BFIs it detects and the UE determined thresholds. If the number of BFIs within a time window is greater than or equal to the UE determined one of the fourth threshold or the fifth threshold, the UE may begin BFR procedure and determine a new beam (e.g., NCB with the highest RSRP) from the activated NCB RSs based on measured or predicted beam qualities (e.g., RSRP) out of the activated NCB RSs. The UE may select the fourth or the sixth threshold for determining beam failure based on the quality of the beam predictions.

The UE may transmit one or more UL channels and signals (e.g., PRACH, MAC CE, PUCCH, PUSCH, and SRS) (e.g., a PRACH in the PRACH resource in a CFRA procedure for beam failure indication and new beam indication) based on the determined BFR mode. For example, if the UE determines the first BFR mode, the UE may transmit the one or more UL channels and signals with the first UL sequence and/or the UL PRACH resource. If the UE determined the second BFR mode, the UE may transmit the one or more UL channels and signals with the second UL sequence and/or the second UL resource.

The UE may monitor for PDCCH associated with BFR (e.g., the PDCCH confirms the beam failure indication and/or confirmation of new beam selected and indicated by the UE) based on the determined BFR mode. For example, if the UE determined the first BFR mode, the UE may monitor for PDCCH in the first CORESET/search space. If the UE determined the second BFR mode, the UE may monitor for the PDCCH in the second CORESET/search space.

As can be seen, a Wireless Transfer/Receive Unit, WTRU, can determine a quality of prediction related to at least one reference signal, determine a beam failure recovery mode based on the quality of prediction, determine a set of beam failure recovery parameters based on the quality of prediction, determine at least one beam failure, and, upon determining a number of beam failures determine, based on measurements on the reference signals, a determined reference signal for a candidate beam among the at least one reference signals for candidate beams, wherein the parameter is based on a measured parameter for a reference signal of the first type and the parameter is predicted for a reference signal of the second type, transmit, a message based on the beam failure recovery mode, and monitor, using a resource set or signal based on the type of determined reference signal, for a response.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method at a Wireless Transmit/Receive Unit, WTRU, the method comprising:
determining a quality of prediction related to at least one reference signal;
determining a beam failure recovery mode based on the quality of prediction, wherein a first beam failure recovery mode is determined in case the quality of prediction is below a first given value and wherein a second beam failure recovery mode is determined in case the quality of prediction is above a second given value;
determining a set of beam failure recovery parameters based on the quality of prediction;
determining at least one beam failure based on the beam failure recovery parameters;
upon determining a number of beam failures:
determining, based on at least one determined value related to the at least one reference signal for candidate beams, a determined reference signal for a candidate beam among the at least one reference signal for candidate beams, wherein the at least one determined value is based on a measurement of a reference signal for a candidate beam of a first type and wherein the at least one determined value is predicted for a reference signal of a second type, wherein, in the first beam failure recovery mode, only candidate beams of the first type are used to determine the reference signal for the candidate beam and wherein, in the second beam failure recovery mode, candidate beams of both the first type and the second type are used to determine the reference signal for the candidate beam;
transmitting; a message based on the beam failure recovery mode; and
monitoring, using a resource set or signal based on the type of determined reference signal, for a response.

2. The method of claim 1, wherein candidate beams of the first type are measurable by the WTRU, the method comprising measuring at least one candidate beam to obtain the measurement.

3. The method of claim 1, comprising predicting the at least one determined value for the reference signal of the second type.

4. The method of claim 1, wherein the quality of prediction is based on a difference between a predicted value and an estimated value for the at least one reference signal.

5-8. (canceled)

9. The method of claim 1, wherein the number of beam failures is equal to a first number of beams of the first type and a second number of beams of the second type.

10. The method of claim 1, wherein the determined reference signal is determined on condition that the determined number of beam failures occur within a given time period.

11. A wireless transmit/receive unit, WTRU, comprising at least one processor configured to:
determine a quality of prediction related to at least one reference signal;
determine a beam failure recovery mode based on the quality of prediction, wherein the at least one processor is configured to determine a first beam failure recovery mode in case the quality of prediction is below a first given value and wherein the at least one processor is configured to determine a second beam failure recovery mode in case the quality of prediction is above a second given value;
determine a set of beam failure recovery parameters based on the quality of prediction;
determine at least one beam failure based on the beam failure recovery parameters;
upon determining a number of beam failures:
determine, based on at least one determined value related to the at least one reference signal for candidate beams, a determined reference signal for a candidate beam among the at least one reference signal for candidate beams, wherein the at least one determined value is based on a measurement of a reference signal for a candidate beam of a first type and wherein the at least one determined value is predicted for a reference signal of a second type, wherein the at least one processor is configured to, in the first beam failure recovery mode, use only candidate beams of the first type to determine the reference signal for the candidate beam and wherein the at least one processor is configured to, in the second beam failure recovery mode, use candidate beams of both the first type and the second type to determine the reference signal for the candidate beam;
transmit; a message based on the beam failure recovery mode; and
monitor, using a resource set or signal based on the type of determined reference signal, for a response.

12. The WTRU of claim 11, wherein candidate beams of the first type are measurable by the WTRU, and wherein the at least one processor is configured to measure at least one candidate beam to obtain the measurement.

13. The WTRU of claim 11, wherein the at least one processor is configured to predict the at least one determined value for the reference signal of the second type.

14. The WTRU of claim 11, wherein the quality of prediction is based on a difference between a predicted value and an estimated value for the at least one reference signal.

15-18. (canceled)

19. The WTRU of claim 11, wherein the number of beam failures is equal to a first number of beams of the first type and a second number of beams of the second type.

20. The WTRU of claim 11, wherein the at least one processor is configured to determine the determined reference signal on condition that the determined number of beam failures occur within a given time period.
